(19) United States
(12) Patent Application Publication
(10) Pub. No.: US 2009/0156291 A1
(43) Pub. Date: Jun. 18, 2009

(54) Gaming Machine

(75) Inventor: Yukinori INAMURA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/176,742

(22) Filed: Jul. 21, 2008

Related U.S. Application Data
(60) Provisional application No. 61/013,417, filed on Dec. 13, 2007.

(51) Int. Cl. A63F 9/24; A63F 13/00

(52) U.S. Cl. 463/20; 463/26

(57) ABSTRACT

A gaming machine includes plural stations and a processor. Each station can determine a game result and execute a game independently. The processor accepts each station's entry to an event game when a predetermined condition is satisfied. The gaming machine awards an event game payout and an opportunity to execute a chance game, to a station which has achieved the best game result, among stations that have participated in the event game. Then, if the chance game is won, the gaming machine awards a chance game payout to the station. If the chance game is lost, the gaming machine carries over the chance game payout to the next chance game payout or later.

### CROSS-REFERENCE TO THE RELATED APPLICATION (S)

This application is based upon and claims a priority from the U.S. provisional Patent Application No. 61/013,417 filed on Dec. 13, 2007, the entire contents thereof are incorporated herein by reference.

### BACKGROUND

1. Technical Field

The present invention encompassing one or more aspects thereof relates to a gaming machine comprised of a plurality of stations. More particularly, it relates to a gaming machine wherein a game result is determined and a game can be executed independently for each of the stations.

2. Description of Related Art

Various gaming machines have conventionally been installed in game arcades and the like. As one of the examples of them, stand-alone-type gaming machines have been available. In such stand-alone-type gaming machines, a game result is determined for a gaming machine separately, i.e., a game for the single gaming machine is executed separately from games for other gaming machines. That is, a game for this type of gaming machine can go with a single gaming machine (i.e., a processor for determining a game result) and a player seated thereat. This type of gaming machine has ordinarily been installed in game arcades, which makes it difficult to create players' novel attraction toward game.

As one aspect of gaming machines to be installed in game arcades and the like, a gaming machine comprised of a plurality of consoles has been available. In such a gaming machine, a game (e.g., baccarat, poker, and the like) is executed with a player seated at each of the plurality of consoles and a processor. That is, in the gaming machine, the processor determines a game result common to each of the plurality of consoles. For example, in case of baccarat, the processor determines a game result from any one of choices, namely, “TIE”, “BANKER” and “PLAYER” so as to serve as a dealer. Players anticipate a game result to be determined by the processor and carry out bet operation using gaming values at their respective consoles. In case the game result coincides with an anticipation on which a player has bet, the player can win a predetermined valued prize.

That is, the gaming machine comprised of the plurality of the consoles executes a game with each of the players and the processor, similar to the stand-alone-type gaming machine. In this regard, in the gaming machine comprised of the plurality of the consoles, a plurality of players seated at their respective consoles share a game result. However, the share of a single game result with plural players does not create novel characteristics of a game to be executed with the gaming machine. That is, characteristics of a game executed with the gaming machine comprised of the plurality of the consoles are as ordinary as those of a game executed by a stand-alone-type gaming machine.

The object of the present invention encompassing one or more aspects thereof is to provide a gaming machine capable of executing a game of which characteristics are novel to characteristics of conventional games so as to heighten players' interest to the game.

### SUMMARY OF THE INVENTION

Therefore, in order to achieve the object, according to a gaming machine of the present invention encompassing one or more aspects thereof, there is provided a gaming machine. The gaming machine comprises plural stations and a processor. Each of plural stations determines a game result and executes a base game independently. When a predetermined condition is satisfied, the processor accepts each station's entry to an event game. The event game is a game in which each station determines the game result independently and is executed in common at plural stations. The processor executes the event game at stations of which entries to the event game have been accepted. The processor determines a first special prize to each station based on a game result of the event game, and awards the first special prize to each station individually. Accordingly, the gaming machine provides a player with game including game aspects that conventional ones did not have.

Further, the processor gives a chance game which may award a second special prize, to a station specified in accordance with a game result of the event game. When executing a chance game, the processor determines whether or not to award a second special prize by a lottery. In the case of winning in the lottery, the processor awards the second special prize to the station. The gaming machine can further enhance the interest directed to the event game by giving an opportunity which may award a second special prize, based on a game result of the event game.

According to the present invention encompassing one or more aspects thereof, there is provided a gaming machine. The gaming machine comprises plural stations and a processor. Each of plural stations determines a game result and executes a base game independently. When a predetermined condition is satisfied, the processor accepts each station's entry to an event game. The event game is a game in which each station determines the game result independently and is executed in common at plural stations. The processor executes the event game at stations of which entries to the event game have been accepted. The processor determines a first special prize to each station based on a game result of the event game, and awards the first special prize to each station individually. Accordingly, the gaming machine provides a player with game including game aspects that conventional ones did not have.

The processor specifies a station which has achieved a best game result by comparing respective game results of each station at the event game. The processor gives a chance game to the station specified thereby so as to determine whether or not to award the second special prize by a lottery. In case the second special prize is won with the lottery, the processor awards the second special prize to the station. The gaming machine gives an opportunity which may award a second special prize to a station which has achieved a best game result of the event game. Accordingly, the gaming machine can further enhance the interest directed to the event game.

According to the present invention encompassing one or more aspects thereof, there is provided a gaming machine. The gaming machine comprises plural stations and a processor. Each of plural stations determines a game result and executes a base game independently. When a predetermined condition is satisfied, the processor accepts each station's entry to an event game. The event game is a game in which each station determines the game result independently and is executed in common at plural stations. The processor executes the event game at stations of which entries to the event game have been accepted. The processor determines a first special prize to each station based on a game result of the event game, and awards the first special prize to each station individually. Accordingly, the gaming machine provides a player with game including game aspects that conventional ones did not have.

The processor specifies a station which has achieved a best game result by comparing respective game results of each station at the event game. The processor gives a chance game to the station specified thereby so as to determine whether or not to award the second special prize that is the progressive payout, by a lottery. In the case of winning in the lottery, the processor awards the second special prize to the station. On the other hand, the second special prize is not won with the lottery, the processor carries over the progressive payout according to the second special prize to a next chance game or later. The gaming machine gives an opportunity which may award to the progressive payout according to the second special prize, to the station which has achieved a best game result of the event game. Thus, the gaming machine can further enhance the interest directed to the event game.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a flowchart of an event game monitoring process program according to one embodiment of the present invention;

FIG. 2 is an external view of a gaming machine according to one embodiment of the present invention;

FIG. 3 is an external view of a station according to one embodiment of the present invention;

FIG. 4 is an explanatory view concerning a variety of symbols according to one embodiment of the present invention;

FIG. 5 is an explanatory view showing one example of a reel according to one embodiment of the present invention;

FIG. 6 is an explanatory view showing a control system of a gaming machine according to one embodiment of the present invention;

FIG. 7 is an explanatory view concerning a control system of a station according to one embodiment of the present invention;

FIG. 8 is an explanatory view concerning a configuration of a sub-control board installed in a station according to one embodiment of the present invention;

FIG. 9 is an explanatory view showing a display example of a main liquid crystal panel with scroll-displayed symbols thereon according to one embodiment of the present invention;

FIG. 10 is an explanatory view showing a display example of a main liquid crystal panel with repositioned symbols thereon according to one embodiment of the present invention;

FIG. 11 is an explanatory view concerning a payout table of a gaming machine according to one embodiment of the present invention;

FIG. 12 is a flowchart of a main control process program according to one embodiment of the present invention;

FIG. 13 is a flowchart of a chance game process program according to one embodiment of the present invention;

FIG. 14 is an explanatory view concerning a chance game result lottery table according to one embodiment of the present invention;

FIG. 15 is a flowchart of a main game process program according to one embodiment of the present invention;

FIG. 16 is an explanatory view showing one example of tables which relates reel symbols to code numbers according to one embodiment of the present invention;

FIG. 17 is an explanatory view showing one example of tables which relates code numbers concerning reels to random number values, according to one embodiment of the present invention;

FIG. 18 is a flowchart of an event game execution process program according to one embodiment of the present invention;

FIG. 19 is an explanatory view concerning an event game point table according to one embodiment of the present invention;

FIG. 20 is a flowchart of a chance game execution process program according to one embodiment of the present invention;

FIG. 21 is an explanatory view showing one display example of a chance game screen according to one embodiment of the present invention;

FIG. 22 is an explanatory view showing one example of one display example of a chance game result concerning a chance game screen according to one embodiment of the present invention; and

FIG. 23 is an external view of a gaming machine according to one embodiment of the present invention.

### DETAILED DESCRIPTION OF THE PREFERRED EMBODIMENTS

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given on the inventive gaming machine as embodied in a gaming machine 100 by referring to drawings.

A gaming machine 100 directed to the present embodiment is constituted of a plurality of stations 1 (for instance, five stations). In the gaming machine 100, each station 1 executes a base game independently. If predetermined conditions to be described later are satisfied, the gaming machine 100 accepts entry of each station 1 with respect to an event game. In this event game, stations 1 which have entered this event game compete to win an event game payout which is a progressive payout.

In the event game, stations 1 which have entered the event game execute plural times of unit event games independently during a predetermined period (hereinafter referred to as event game period). The result of the event game is constituted by putting together the game results in unit event games executed during an event game period. When the event game period is over, the station with the best game result in the event game is identified among stations 1 entering the event game. The player at the identified station 1 receives the event game payout.

Further, a chance game is awarded to the station 1 with the best game result in the event game. A chance game is a game intended to win a chance game payout. The chance game payout is a progressive payout, different from the above-mentioned event game payout. The presence or absence of a payout directed to the chance game payout is determined by a lottery referring to a chance game payout reference table to be described later. When winning this lottery, the player directed to the station 1 can win a chance game payout together with an event game payout. When losing the lottery directed to the chance game payout, the player is awarded an event game payout only, but not a chance game payout. The chance game payout in this case is used for a next or later chance game payout.

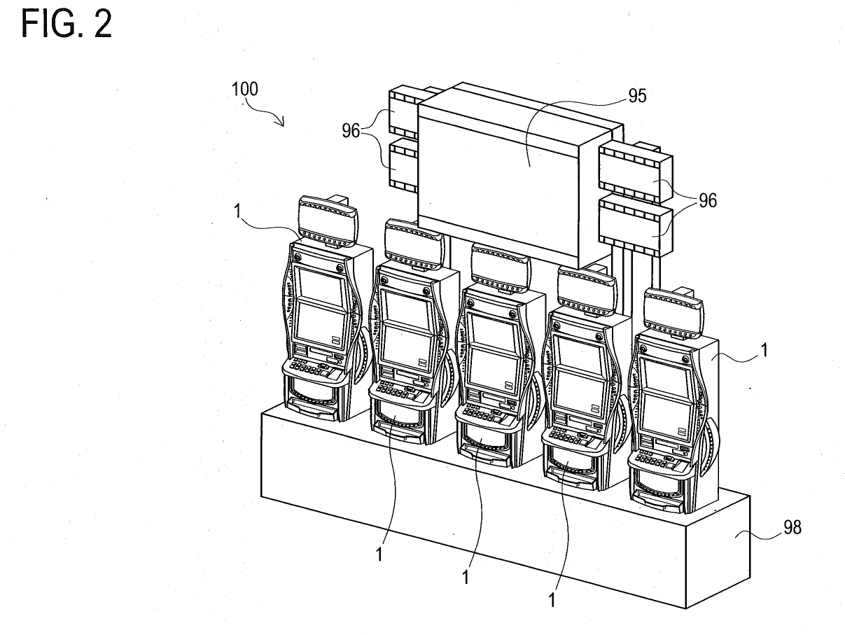

Here, a schematic construction of the gaming machine 100 directed to the present embodiment will be described by referring to the drawings. FIG. 2 is a perspective view showing an exterior appearance of the gaming machine 100 directed to the present embodiment.

As shown in FIG. 2, the gaming machine 100 has five stations 1. Stations 1 are all mounted in line on an installation base 98. In the gaming machine 100, players execute different types of games (i.e., the base game and the event game to be described later) using the respective stations 1. This installation base 98 houses an overall controller 91 and the like to be described later.

The gaming machine 100 also has a large display device 95 and a light emitting effect device 96. The large display device 95 and the light emitting effect device 96 are mounted above the five stations 1 installed on the installation base 98. The large display device 95 is a heretofore known large liquid crystal display and is adapted to display different types of game information (for instance, game rules and game score for each station 1, or the like) in the gaming machine 100. The light emitting effect device 96 has the effect of enhancing interest in the gaming machine 100 by emitting light in a predetermined fashion.

The large display device 95 and the light emitting effect device 96 are supported by a support member arranged at the backside of the installation base 98 (refer to FIG. 2). Specifically, stations 1 installed on the installation base 98 are spaced away from the large display device 95 and the light emitting effect device 96. Thus, according to the gaming machine 100, the manager, etc. of the game arcade can replace the stations 1 on the installation base 98 without the need to remove the large display device 95 and the light emitting effect device 96.

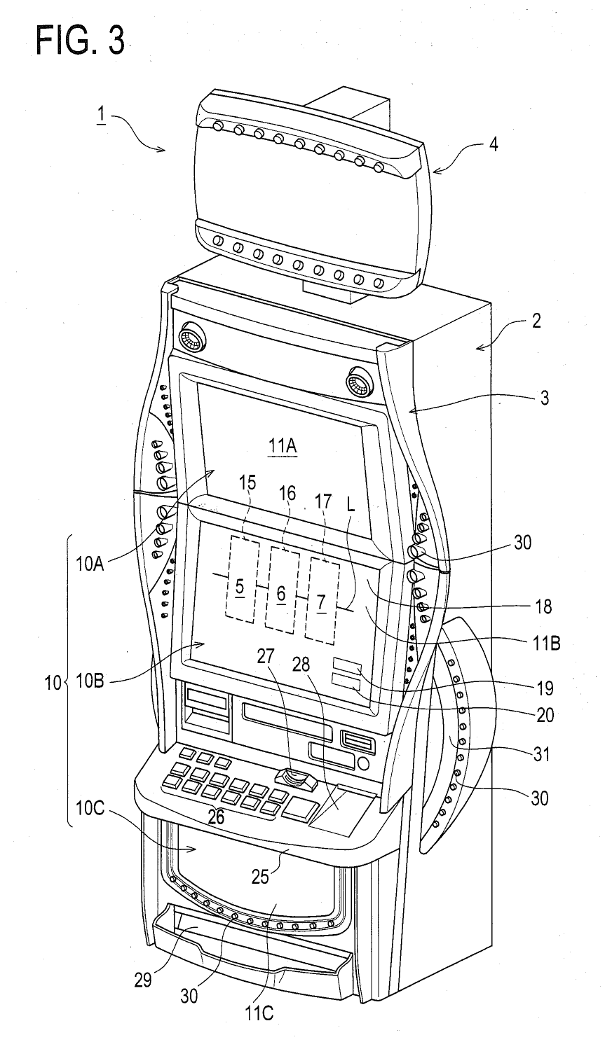

Next, stations 1 composing the gaming machine 100 directed to the present embodiment will be described in detail by referring to the drawings. FIG. 3 is a perspective view showing an external appearance of one station 1 composing the gaming machine 100.

Station 1 directed to the present embodiment is a so-called hybrid-type slot machine. This hybrid-type slot machine has a heretofore known transparent liquid crystal panel arranged at a front face of a plurality of mechanical reels that are rotatably supported. This hybrid-type slot machine displays images of different types of symbols drawn on an outer surface of the mechanical reels, while the transparent liquid crystal panel is in a transmission state upon execution of the game.

Station 1 directed to the present embodiment is an upright-type slot machine used in game arcades such as casinos and the like. This station 1 has a cabinet 2, a main door 3 and a topper effect device 4. The main door 3 is arranged at a front face of the cabinet 2. The topper effect device 4 is arranged at an upper side of the cabinet 2.

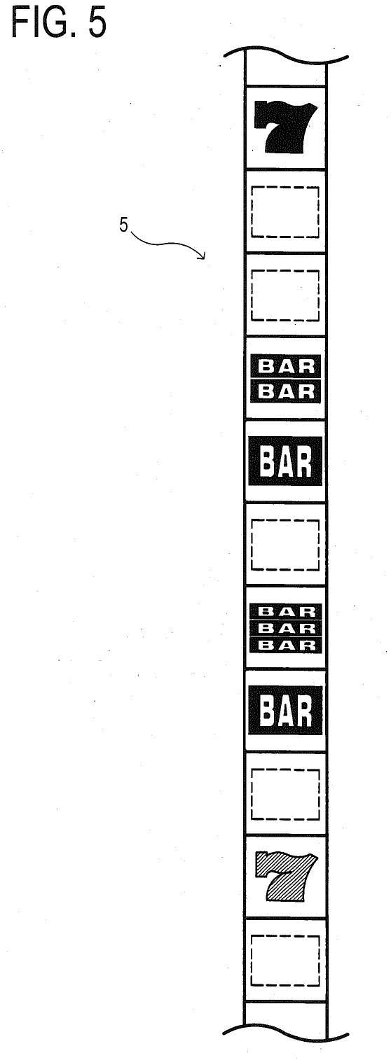

Cabinet 2 is a housing portion that houses the electrical and mechanical components for executing a predetermined game mode in station 1. Cabinet 2 has three reels (specifically, left reel 5, center reel 6 and right reel 7) which are rotatably provided therein. Reels 5 through 7 each have a symbol column drawn on an outer periphery thereof (refer to FIG. 5). The symbol column is constituted of a predetermined number of symbols (for instance, blue seven symbol 90A and the like to be described later). A main liquid crystal panel 11B to be described later is arranged in front of the reels 5 though 7.

The main door 3 has an upper display portion 10A, a variable display portion 10B and lower display portion 10C provided as a display portion 10 for displaying information with respect to the game. The upper display portion 10A is constituted of an upper liquid crystal panel 11A arranged above the variable display portion 10B. The upper liquid crystal panel 11A displays, for instance, effect images, introduction to game contents, explanation of game rules, and the like.

The variable display portion 10B is constituted of the main liquid crystal panel 11B and is adapted to display an execution state of the game. The main liquid crystal panel 11B is a heretofore known transparent liquid crystal panel secured to the main door 3.

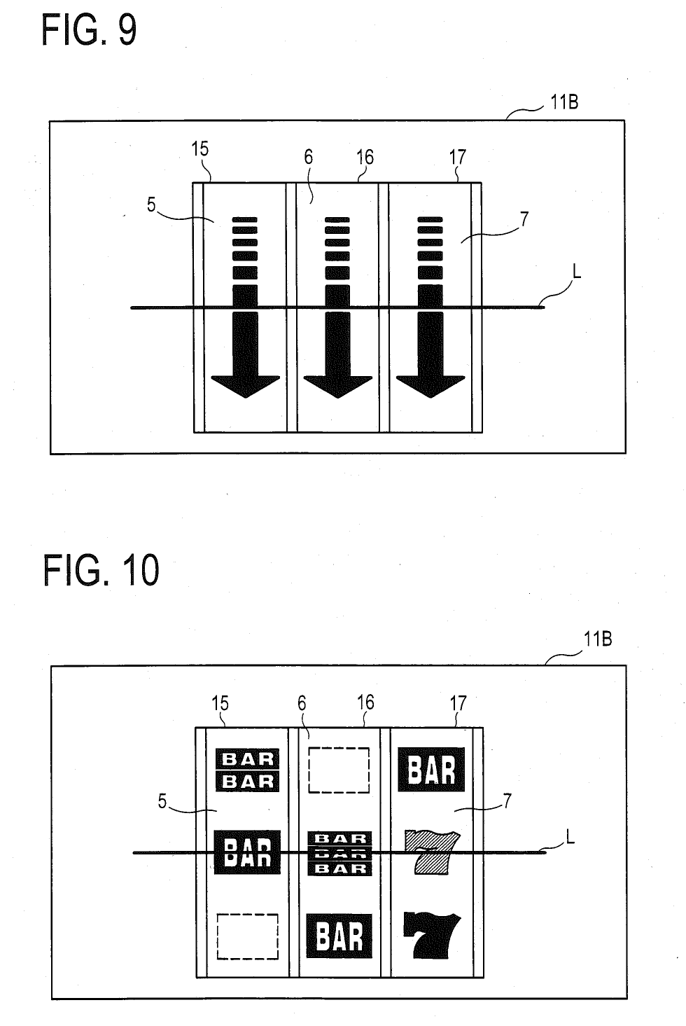

The main liquid crystal panel 11B has three display windows 15, 16 and 17 formed therein (refer to FIG. 3). Station 1 renders the backside of the display windows 15, 16 and 17 visible by placing these display windows in a transmission state. As a result, a player can visually recognize the symbols drawn on reels 5 through 7 via the respective display windows 15 through 17 (refer to FIG. 9 and FIG. 10).

As shown in FIG. 3, etc., one pay line L is displayed on the main liquid crystal panel 11B in the variable display portion 10B. This pay line L is a line that runs in a horizontal direction across a mid portion of the symbol display area corresponding to reels 5 through 7 and defines a symbol combination. Accordingly, if the symbol combination that was repositioned on the pay line L is a predetermined winning combination, the station 1 awards a payout in accordance with the winning combination and the credit amount that was bet (bet amount).

The number of reels may be five, instead of three, and further, the number of displayed symbols is not limited to nine symbols.

A touch panel 18 is provided at a front face of the main liquid crystal panel 11B. Thus, the player can input different types of commands by operating the touch panel 18. In the present embodiment, the touch panel 18 is used at the time of an entry operation with respect to an event game and a scratch operation at a chance game to be described later.

A payout amount display portion 19 and a credit amount display portion 20 are provided at a right lower part of the variable display portion 10B. The payout amount display portion 19 displays the payout amount and the like as the awarded payout amount. The payout amount display portion 19 displays a payout amount which is awarded if the symbol combination repositioned on the pay line L in a base game is a predetermined combination. On the other hand, the credit amount display unit 20 displays the credit amount that an actual player has.

The lower display portion 10C is arranged below the variable display portion 10B. This lower display portion 10C is constituted of a plastic panel 11C onto which an image is printed. In the lower display portion 10C, the plastic panel 11C is illuminated by backlights.

An operation table 25 is provided at a front face of the cabinet 2. The operation table 25 is arranged between the variable display portion 10B and the lower display portion 10C so as to protrude towards the front side. A plurality of types of operation buttons 26 are arranged on this operation table 25. Operation buttons 26 include a BET button, a collecting button, a start button and a CASHOUT button and the like. The operation table 25 has a coin insertion slot 27 and a bill insertion portion 28. The coin insertion slot 27 accepts coins representing gaming value inside the cabinet 2. The bill insertion slot 28 accepts bills inside the cabinet 2.

In the gaming machine 100 (i.e., including station 1) directed to the present embodiment, coins, bills or electronic valuable information (credit) corresponding to these are used as gaming values. However, the gaming values applicable to this invention are not limited to these items and may also include medals, tokens, electronic money or tickets, for instance.

Also, a coin tray 29 is provided at a lowermost portion of the cabinet 2. This coin tray 29 receives the coins paid out by a hopper 64. A light emitting portion 30 is arranged at a periphery of cabinet 2 in station 1. The light emitting portion 30 lights up in a predetermined lighting fashion in the event of a win or during the event game. A speaker 31 is provided at a side face of the cabinet 2 and is adapted to output sounds in accordance with the progress of the game.

Station 1 also has a topper effect device 4 provided at an upper side of cabinet 2. This topper effect device 4 has a rectangular board shape and is arranged so as to become substantially parallel with the upper display portion 10A.

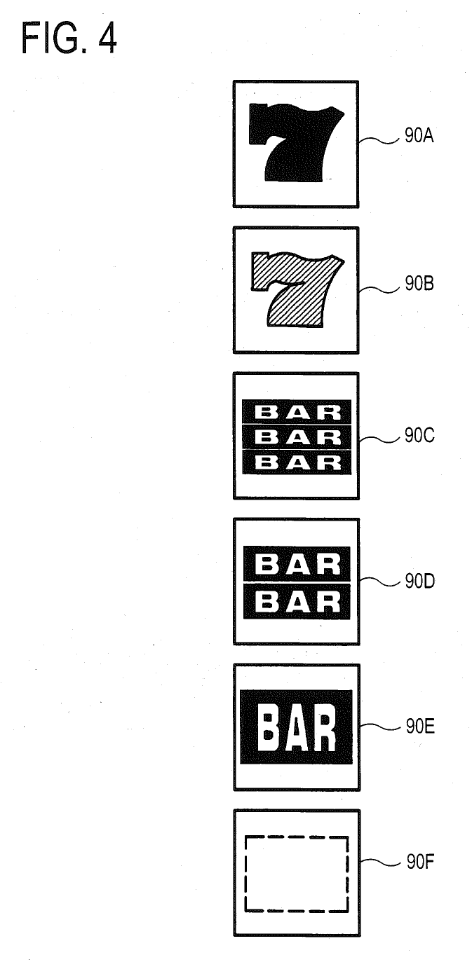

Next, the symbols in the gaming machine 100 directed to the present embodiment will be described by referring to the drawings. FIG. 4 is an explanatory diagram of the respective symbols employed by the gaming machine 100 directed to the present embodiment.

As shown in FIG. 4, the gaming machine 100 employs six types of symbols during the game. The six types of symbols are constituted of a blue seven symbol 90A (BLUE 7), a red seven symbol 90B (RED 7), a triple bar symbol 90C (3-BAR), a double bar symbol 90D (2-BAR), a bar symbol 90E (BAR) and a blank symbol 90F (BLANK).

These six types of symbols constitute a symbol column when a predetermined number thereof are positioned in array (refer to FIG. 5). The reel bands of the left reel 5, the center reel 6 and the right reel 7 each contain a corresponding symbol column. In the symbol columns, the above described symbols are each positioned in a predetermined sequence. Accordingly, in the base game and the event game, station 1 can reposition the symbols while scrolling through the respective display windows 15 through 17 of the main liquid crystal panel 11B.

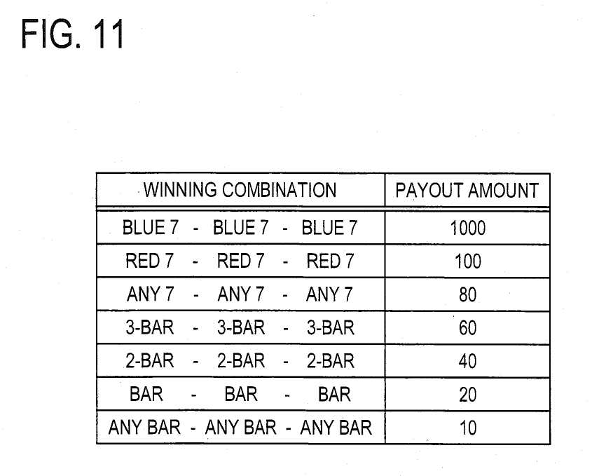

The blue seven symbol 90A through the bar symbol 90E constitute a winning combination if three of them are repositioned on the pay line L of the main liquid crystal panel 11B. In this case, the gaming machine 100 awards a predetermined payout amount to the player based on the relevant winning combination (refer to FIG. 11).

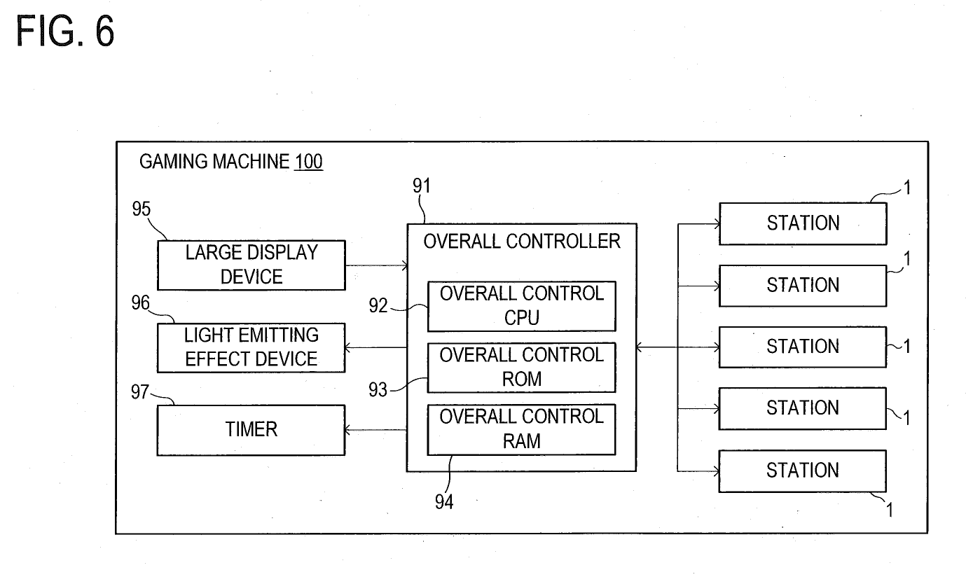

Next, the internal construction of the gaming machine 100 directed to the present embodiment will be described in detail by referring to the drawings. FIG. 6 is a block diagram showing an internal construction of the gaming machine 100.

As shown in FIG. 6, the gaming machine 100 is provided with an overall controller 91. This overall controller 91 executes a control program to be described later (for instance, an event game monitoring process program, etc.) to control the entire gaming machine 100. The overall controller 91 functions as a processor for the gaming machine directed to the present invention, together with controller 41 of each station 1.

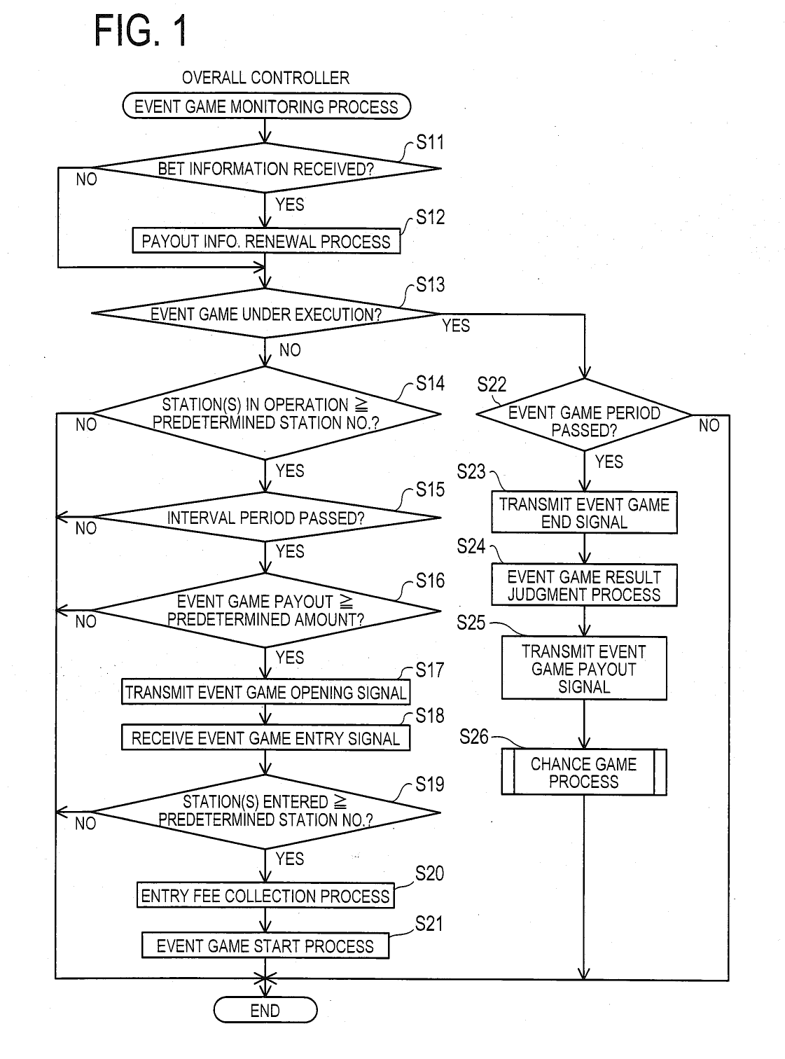

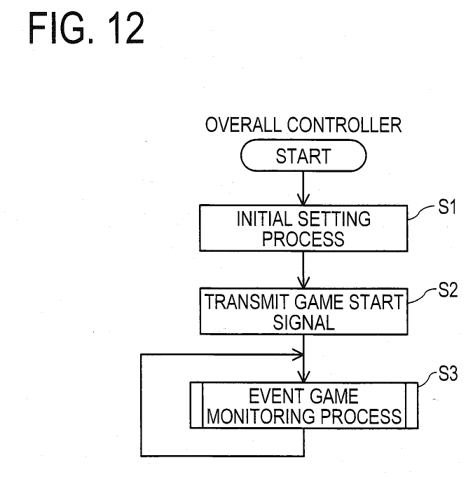

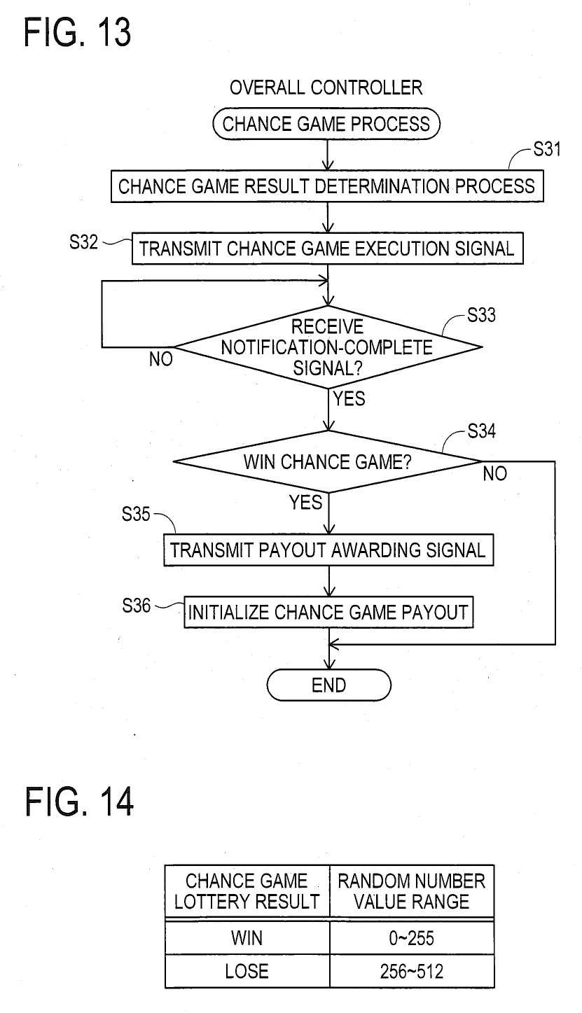

The overall controller 91 is constituted of an overall control CPU 92, an overall control ROM 93 and an overall control RAM 94. The overall control ROM 93 stores a control program and a data table required for controlling the entire gaming machine 100. Accordingly, this overall control ROM 93 stores a main process program to be described later (refer to FIG. 12), an event game monitoring process program (refer to FIG. 1) and a chance game process program (refer to FIG. 13). The overall control ROM 93 also stores a lottery program. This lottery program is used when determining a chance game result (i.e., presence or absence of a payout directed to a chance game payout.) The overall control CPU 92 is a central processing unit that executes the various types of control programs stored in the overall control ROM 93. The overall control CPU 92 serves as the core for controlling the entire gaming machine 100.

The overall control RAM 94 temporarily stores the computed results and the like when the overall control CPU 92 executes a control program. This overall control RAM 94 also stores information with regard to an event game payout to be awarded at an event game (hereinafter referred to as event game payout information). This event game payout is a progressive payout as will be described later. Accordingly, this event game payout information stored in the overall control RAM 94 is renewed as needed upon reception of bet information and the like from each station 1. Further, this overall control RAM 94 stores information with regard to a chance game payout to be awarded at a chance game (hereinafter referred to as chance game payout information). This chance game payout is also a progressive payout as well as the event game payout. That is, as well as the event game payout information, the chance game payout information is also renewed as needed upon reception of bet information and the like.

The five stations 1 constituting the gaming machine 100 are each connected to the overall controller 91. Thus, the overall controller 91 can transmit and receive different types of data to/from each one of the five stations 1. The overall controller 91 can thus control each station 1 based on the control program stored in the overall control ROM 93. Specifically, the overall controller 91 can control the event game and the chance game with respect to the entire gaming machine 100 by executing an event game monitoring process program to be described later.

A timer 97 serving as a timing device is connected to the overall controller 91. This timer 97 is referenced when judging whether one of the event game start conditions is satisfied in an event game monitoring process program. This timer 97 is also referenced when judging the lapse of an event game execution period (hereinafter referred to as event game period).

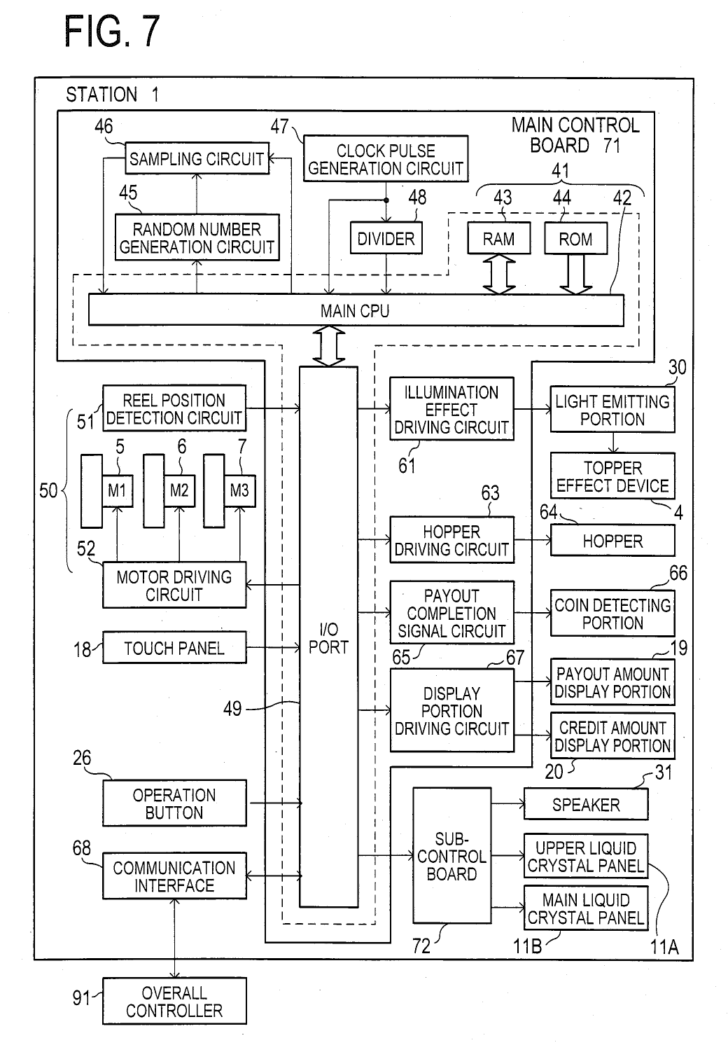

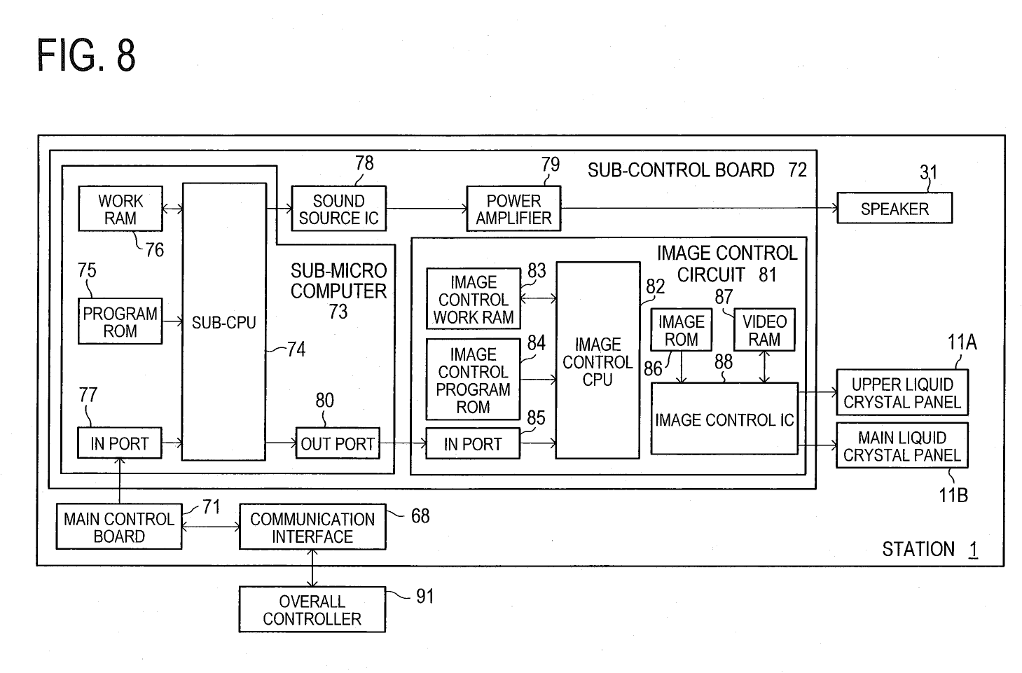

Next, the internal construction of station 1 directed to the present embodiment will be described in detail by referring to the drawings. FIG. 7 is a block diagram showing the internal construction of station 1.

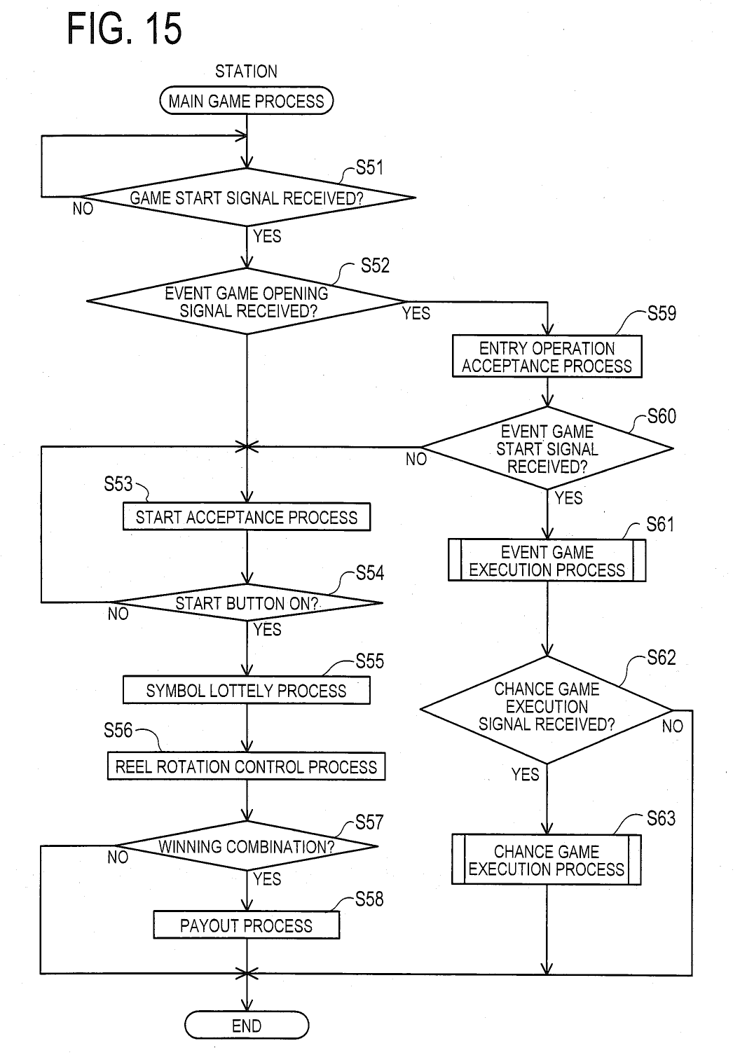

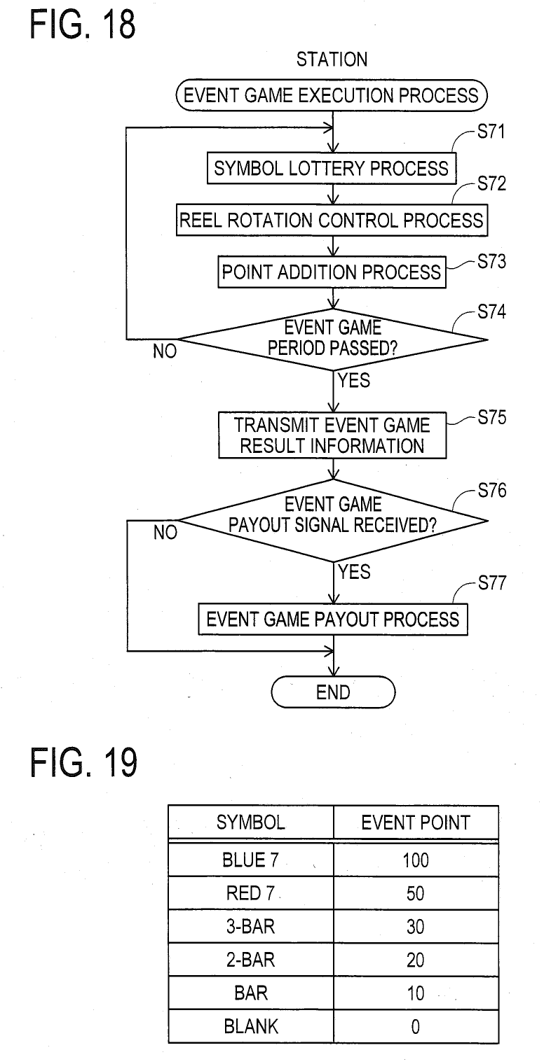

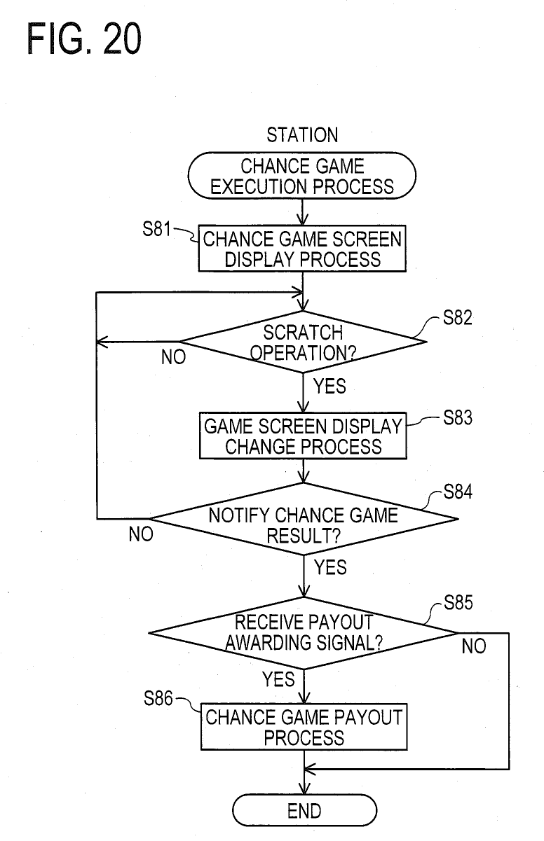

As shown in FIG. 7, station 1 has a plurality of constituting elements, with a main control board 71 as a core. The main control board 71 has a controller 41 for executing control programs and the like to be described later (FIG. 15, FIG. 18 and FIG. 20). As was described in the above, the controller 41 functions as a processor in the present invention, together with the overall controller 91.

Controller 41 has a main CPU 42, a RAM 43 and a ROM 44. The main CPU 42 inputs/outputs signals to/from the other constituting elements through an I/O port 49 to execute a program stored in ROM 44. The main CPU 42 thus serves as the core for controlling station 1. RAM 43 temporarily stores data and programs to be used when the main CPU 42 is operational. For instance, RAM 43 temporarily stores random number values which were sampled by a sampling circuit 46 to be described later. ROM 44 stores permanent data and programs to be executed by the main CPU 42.

More particularly, the programs stored in ROM 44 include a game program and a game system program (hereinafter referred to as a game program, etc.). Further, this game program also includes a lottery program.

The lottery program serves to decide code numbers for each reel 5 through 7. These code numbers correspond to symbols each repositioned on the pay line L, as will be described later. This lottery program includes symbol weighting data. The symbol weighting data correspond to plural types of payout rate (e.g., 80%, 84% and 88%) respectively. The symbol weighting data show the correspondence relation between each code number and one or plural random numbers falling within a predetermined range of number with regard to the respective three reels 5 through 7.

The main control board 71 has the controller 41, a random number generation circuit 45, a sampling circuit 46, a clock pulse generation circuit 47 and a divider 48.

The random number generation circuit 45 operates in response to a command from the main CPU 42 to generate random numbers in a definite range. The sampling circuit 46 extracts an arbitrary random number from the random numbers generated by the random number generation circuit 45 in response to a command from the main CPU 42. The sampling circuit 46 inputs the extracted random number to the main CPU 42. The clock pulse generation circuit 47 generates a reference clock for activating the main CPU 42. Then, the divider 48 inputs a signal obtained by dividing the reference clock by a fixed period, to the main CPU 42.

A reel driving unit 50 is connected to the main control board 71. This reel driving unit 50 has a reel position detection circuit 51 and a motor driving circuit 52. The reel position detection circuit 51 detects the stop position for each one of the left reel 5, the center reel 6 and the right reel 7. The motor driving circuit 52 inputs a driving signal to motors M1, M2 and M3 which are connected to reels 5 through 7, respectively. Motors M1, M2 and M3 are activated in response to a driving signal inputted from the motor driving circuit 52. As a result, motors M1, M2 and M3 respectively spin reels 5 through 7, and stop them at a desired position.

A touch panel 18 is also connected to the main control board 71. This touch panel 18 identifies the coordinate position of the portion a player has touched. The touch panel 18 identifies where the player touched the panel and in which direction the touched location has moved based on the identified coordinate position information. The touch panel 18 inputs a signal corresponding to the identification results to the main CPU 42 through the I/O port 49.

Operation buttons 26 are also connected to the main control board 71. As was already described, the operation buttons 26 include a start button for instructing execution of the game, a collecting button, a BET button, etc. The buttons included in the operation buttons 26 each input an operation signal to the main CPU 42 through the I/O port 49 upon being held down.

A communication interface 68 is connected to the main control board 71. This communication interface 68 is employed during transmission and reception of different types of data (for instance, bet information, game results of the event game, etc.) between the station 1 and the overall controller 91.

The main control board 71 also has an illumination effect driving circuit 61, a hopper driving circuit 63, a payout completion signal circuit 65 and a display portion driving circuit 67.

The illumination effect driving circuit 61 outputs an effect signal with respect to the above-described light emitting portion 30 and the topper effect device 4. The topper effect device 4 is connected in series with the illumination effect driving circuit 61 through the light emitting portion 30. When an effect signal is received, the light emitting portion 30 and the topper effect device 4 emit light in a predetermined light emitting pattern. As a result, station 1 has an illumination effect in accordance with the progress of the game.

The hopper driving circuit 63 drives a hopper 64 based on the control of the main CPU 42. As a result, the hopper 64 performs a coin payout operation whereby coins are paid out to the coin tray 29. The display portion driving circuit 67 then controls display of the respective display portions including the payout amount display portion 19, the credit amount display portion 20 and the like.

As shown in FIG. 7, a coin detecting portion 66 is connected to the payout completion signal circuit 65. The coin detecting portion 66 measures the number of coins paid out by the hopper 64 and then inputs data on the measured amount of coins to the payout completion signal circuit 65. The payout completion signal circuit 65 judges whether a set number of coins has been paid out, based on the coin amount data inputted from the coin detecting portion 66. If the set number of coins has been paid out, the payout completion signal circuit 65 inputs a signal showing completion of coin payout to the main CPU 42.

As shown in FIG. 7, a sub-control board 72 is connected to the main control board 71. This sub-control board 72 is composed on a circuit board that differs from the main control board 71. The sub-control board 72 controls display of the upper liquid crystal panel 11A and the main liquid crystal panel 11B and controls sound output by speaker 31 based on a command inputted from the main control board 71.

The sub-control board 72 has a micro computer (hereinafter referred to as a sub-micro computer 73) as a main constituting element thereof. The sub-micro computer 73 has a sub-CPU 74, a program ROM 75, a work RAM 76, and I/O ports 77 and 80. The sub-CPU 74 performs a control operation in accordance with a control command transmitted from the main control board 71. The program ROM 75 stores a control program executed by the sub-CPU 74. The work RAM 76 is constituted as a temporary storage section for use when the above control program is executed by the sub-CPU 74.

The sub-control board 72 executes random number sampling upon an operation program of the sub-CPU 74. The sub-control board 72 carries out processes similar to those of the clock pulse generation circuit 47, the divider 48, the random number generation circuit 45 and the sampling circuit 46 provided on the main control board 71.

The sub-control board 72 also has a sound source IC 78, a power amplifier 79 and an image control circuit 81. The sound source IC 78 controls the sound outputted from the speaker 31. The power amplifier 79 amplifies the sound output. The image control circuit 81 operates as a display control section of the upper liquid crystal panel 11A and the main liquid crystal panel 11B.

The image control circuit 81 has an image control CPU 82, an image control work RAM 83, an image control program ROM 84, an image ROM 86, a video RAM 87 and an image control IC 88. The image control CPU 82 decides the image to be displayed on the upper liquid crystal panel 11A and the main liquid crystal panel 11B in accordance with the image control program and the parameters set in the sub-micro computer 73.

The image control program ROM 84 stores an image control program and different types of select tables relating to the display for the upper liquid crystal panel 11A and the main liquid crystal panel 11B. The image control work RAM 83 is a temporary storage section used when the image control program is executed in the image control CPU 82. The image control IC 88 forms images according to the contents decided by the image control CPU 82 and outputs these images to the upper liquid crystal panel 11A and the main liquid crystal panel 11B. The image ROM 86 stores dot data for forming images. The video RAM 87 functions as a temporary storage section for use when an image is formed by the image control IC 88.

Next, a description will be given on the base game, the event game and the chance game executed in the gaming machine 100 according to the present embodiment.

First, the base game in the gaming machine 100 will be described. The base game is a slot game executed separately in each station 1. Specifically, the base game is a slot game in which a payout is acquired by repositioning a specific symbol combination on a pay line L of reels 5 through 7.

More specifically, when the base game starts, the player first operates the operation buttons 26 to set the number of bets. Then, when the player holds down the start button, reels 5 through 7 start spinning. The symbol columns drawn on the reels 5 through 7 are each scroll displayed in a downward direction in the display windows 15 through 17 each of which are in a transparent state (refer to FIG. 9).

When a predetermined time has lapsed, reels 5 through 7 each stop automatically in a predetermined sequence. As a result, portions of the symbol columns (three symbols in each reel, a total of 9 symbols) drawn on each of the reels 5 through 7 are respectively repositioned in the respective display windows 15 through 17 which are in a transparent state (refer to FIG. 10).

Here, in the base game, a payout amount is awarded when a predetermined type of winning combination is repositioned on the pay line L. The payout amount is calculated by multiplying the number of bets to the payout in accordance with the winning combination repositioned on the pay line L.

A unit game in the base game is composed of a series of processes ranging from betting of the gaming values to repositioning the symbols and payout (S53 through S58).

Next, the event game in the gaming machine 100 will be described. The event game according to the present embodiment is executed if predetermined conditions are satisfied. Here, the predetermined conditions include: “execution of a base game in a predetermined number of (for instance three) or more stations 1 (S14)”, “non-execution of an event game during a predetermined time (S15)”, “event game payouts are equal to or above a predetermined amount (S16)” and “an entry operation to the event game is made in a predetermined number of (for instance three) or more stations 1 (S19)”. If these conditions are satisfied, the event game is executed.

In this event game, each one of a plurality (specifically, three or more) of stations 1 competes with the rest of the stations 1 for the superiority of game results in the event game. Accordingly, the event game corresponds to a game executed in common by a plurality (specifically, three or more) of stations 1.

The event game is constituted of a plurality of unit event games. In a unit event game, a station 1 executes scroll display of symbols (S72) and then repositioning of the symbols in accordance with a lottery result (S72) similarly to the unit game in the above-mentioned base game. Then an “event game point” is awarded based on the three symbols repositioned on the pay line L at the unit event game. That is, the game result of a unit event game is a sum of event game points based on the three symbols repositioned on the pay line L. This event game point serves as an indication to judge the superiority with regard to the game results in the event game. The event game point does not correspond to the gaming value (credit), different from the payout based on the winning combination.

Similarly to the base game, the unit event game is independently executed in each station 1. Accordingly, the game results of the unit event game are in no way influenced by the game results of the other stations 1.

In the gaming machine 100 according to the present embodiment, when an entry to the event game is made, an entry fee is collected from the player through station 1 (S22). This entry fee represents the counter value for entering the event game. After the entry fee is collected, the above station 1 starts the unit event game. The station 1 executes the unit event game a plurality of times during the event game period. Specifically, each station 1 can execute the unit event game any number of times as long as it is within a predetermined period (hereinafter referred to as an event game period) in the event game. Accordingly, an event game consists of unit event games executed plural number of times during the event game period. After the event game period has lapsed, the event game ends.

Thus, the game results of the event game are obtained by summing up the game results of the unit event game executed a plurality of times in the station 1. Accordingly, the gaming machine 100 compares the game results of the event game in each station 1 with the total value of event game points acquired during the event game period. The gaming machine 100 then identifies the station 1 achieving the best game results in the event game based on the results of this comparison.

Then, an event game payout is awarded in the event game with respect to the station 1 which obtained the best game results in the event game. Accordingly, a player can win an event game payout when obtaining the largest event game point among players entering the event game. Meanwhile, this event game payout is a progressive payout. Specifically, the event game payout is constituted by accumulating and adding the gaming values corresponding to a predetermined ratio of the number of bets made upon execution of the base game, and the collected entry fee.

Furthermore, the player who obtained the best game result at this event game is awarded an opportunity to execute a chance game. The chance game is a game aimed at winning a chance game payout. At the chance game, the player can participate in a lottery for a “Lottery Ticket” the award of which is a chance game payout. This “Lottery Ticket” is a so-called “scratch-off lottery ticket.” The “scratch-off lottery ticket” is a lottery ticket with a scratch objective portion covering a lottery result. The lottery result is notified through scratching and removing the scratch portion. When winning the “Lottery Ticket”, the player is awarded a chance game payout. Accordingly, in this case, the player can obtain both the event game payout and the chance game payout.

Meanwhile, when losing the “Lottery Ticket”, the chance game payout directed to this “Lottery Ticket” is used as a chance game payout at the next or later chance game. As mentioned above, the chance game payout is a progressive payout. Accordingly, a predetermined amount based on bet information, etc. is accumulated and added to the current chance game payout as needed in the game afterwards. As a result, this gaming machine 100 can further enhance the interest directed to the event game and the chance game.

Next, a detailed description will be given on the winning combinations and the associated payout amounts in the base game by referring to the drawings. FIG. 11 is an explanatory diagram of a payout table showing the winning combinations and the payout amount for each winning combination according to the present embodiment.

The payout amounts shown in FIG. 11 represent payout amounts for the case the number of bets is “1”. If the number of bets is “2” or more, the amount to be paid is obtained by multiplying the respective number of bets by a payout amount as shown in FIG. 11.

For instance, if three blue seven symbols 90A are repositioned on the pay line L, an amount obtained by multiplying the number of bets by 1000 credits will be paid out.

If the three symbols repositioned on the pay line L are constituted of blue seven symbol 90 and red seven symbol 90B, an amount obtained by multiplying the number of bets by 80 credits will be paid out. In this case, the blue seven symbol 90A and the red seven symbol 90B included in the three symbols on the pay line L may be positioned in any pattern.

The payout amount for each winning combination shown in FIG. 11 is set in a similar manner. In this case, however, if the three symbols repositioned on the pay line L do not correspond to any of the winning combinations (refer to FIG. 11), the game is a losing. In this case, no payout is made.

Next, the main control program to be executed in the gaming machine 100 according to the present embodiment will be described in detail by referring to the drawings. FIG. 12 is a flow chart of the main control program.

This main control program controls the operation of the entire gaming machine 100. Accordingly, the main control program is executed by the overall control CPU 92 of the overall controller 91.

First, when the power-on switch of the gaming machine 100 is pressed (power is applied), the overall control CPU 92 executes an initial setting process (S1). When the gaming machine 100 is turned on, power is supplied to each station 1.

In this initial setting process (S1), the overall control CPU 92 executes initial setting of the overall controller 91 and the like, and at the same time transmits an initial setting signal to the main CPU 42 of each station 1.

Upon receiving this initial setting signal, each station 1 activates their main control board 71 and the sub-control board 72 to execute an initial setting. During the initial setting, the main CPU 42 of each station 1 executes the BIOS stored in ROM 44 to develop compressed data incorporated in the BIOS to the RAM 43. The main CPU 42 then executes the BIOS developed in the RAM 43 and diagnoses and initializes the various types of peripheral devices. Further, the main CPU 42 writes the game program, etc. from the ROM 44 to the RAM 43 to obtain payout rate setting data and country ID information. During the initial setting, the main CPU 42 also carries out an authentication process with respect to each program.

When the initial setting in each station 1 is completed, the overall control CPU 92 shifts the process to S2.

After shifting to S2, the overall control CPU 92 transmits a game start signal to each station 1. As will be described later, each station 1 can execute the base game and the event game upon receiving this game start signal. After the game start signal is transmitted to each station 1, the overall control CPU 92 shifts the process to S3.

After shifting to process S3, the overall control CPU 92 executes an event game monitoring process. In this event game monitoring process (S3), the overall control CPU 92 carries out an overall control process with respect to the execution of the event game, having as object the entire gaming machine 100. For instance, the overall control CPU 92 carries out an accumulation-addition process of an event game payout and a chance game payout, a process with respect to the start conditions and end conditions of the event game, a process with respect to awarding the event game payout, and a process with respect to executing a chance game. This event game monitoring process (S3) will be described in detail later. When the event game monitoring process (S3) is completed, the overall control CPU 92 executes the event game monitoring process again.

Next, an event game monitoring process program to be executed by the overall control CPU 92 will be described in detail by referring to the drawings. FIG. 1 is a flow chart of the event game monitoring process program.

As shown in FIG. 1, when execution of the event game monitoring process program starts, the overall control CPU 92 first judges whether bet information was received (S11). This bet information shows the amount of gaming values (i.e., numbers of bets) that was bet upon execution of the slot game (base game) in each station 1. This bet information is transmitted from station 1 to the overall controller 91 by executing a start acceptance process (S53) to be described later. If the bet information was received (S11: YES), the overall control CPU 92 shifts the process to S12. On the other hand, if no bet information is received (S11: NO), the overall control CPU 92 shifts the process to S13.

After shifting to process S12, the overall control CPU 92 executes a payout information renewal process. In the payout information renewal process (S12), the overall control CPU 92 renews the contents of the event game payout information and the chance game payout information stored currently in the overall control RAM 94 based on the received bet information. More specifically, the overall control CPU 92 accumulates and adds the gaming values for a predetermined ratio (for instance, 2%) of the number of bets indicated in the bet information to the current event game payout. Similarly, the overall control CPU 92 accumulates and adds the gaming values for a predetermined ratio (for instance, 1%) indicated in the bet information to the current chance game payout. After the event game payout information and the chance game payout information are renewed, the overall control CPU 92 shifts the process to S13.

After shifting to process S13, the overall control CPU 92 judges whether the event game is being executed in the gaming machine 100. More specifically, the overall control CPU 92 references timer 97 to judge whether the gaming machine 100 is within an event game period or not. If the event game is being executed (S13: YES), the overall control CPU 92 shifts the process to S22. In this case, the overall control CPU 92 monitors and controls the being-executed event game (S22 through S26). On the other hand, if the event game is not being executed (S13: NO), the overall control CPU 92 shifts the process to S14. In this case, the overall control CPU 92 monitors and controls the start of the event game (S14 through S21).

At S14, the overall control CPU 92 judges whether a predetermined number (for instance, three) or more stations 1 are operating. In other words, the overall control CPU 92 judges whether the base game is being executed in a predetermined number or more stations 1. More specifically, the overall control CPU 92 identifies the station 1 in which the base game is being executed based on the bet information received during a predetermined time (for instance, 5 minutes) and then makes the judgment of S14. If a predetermined number or more stations 1 are operating (S14: YES), the overall control CPU 92 shifts the process to S15. On the other hand, if the number of stations 1 which are operating is below a predetermined number (S14: NO), the overall control CPU 92 ends the event game monitoring process program as is.

At S15, the overall control CPU 92 judges whether an interval period has lapsed. The interval period is a predetermined time from the end of the previous event game. Accordingly, at S15, the overall control CPU 92 references timer 97 to judge whether the time in which an event game was not executed is equal to or longer than a predetermined time. If the interval period has lapsed (S15: YES), the overall control CPU 92 shifts the process to S16. On the other hand, if the interval period has not lapsed (S15: NO), the overall control CPU 92 ends the event game monitoring process program as is.

After shifting to S16, the overall control CPU 92 references the overall control RAM 94 to determine whether the event game payout is equal to or above a predetermined amount. As was described in the above text, the event game payout is a progressive payout. Accordingly, the event game payout is renewed as needed through the above described payout information renewal process (S12). If the event game payout is equal to or above a predetermined amount (S16: YES), the overall control CPU 92 shifts the process to S17. On the other hand, if the event game payout is below a predetermined amount (S16: NO), the overall control CPU 92 ends the event game monitoring process program as is.

At S17, the overall control CPU 92 transmits an event game opening signal with respect to the stations 1 which are operating at present (i.e., which are executing a base game). After transmitting the event game opening signal, the overall control CPU 92 shifts the process to S18. As will be described later, upon receiving the event game opening signal, the main CPU 42 of the station 1 executes an entry operation acceptance process (S59). Here, the main CPU 42 informs the player about the necessity of an entry fee for playing an event game. In this case, the player of the above station 1 can perform an entry operation with respect to the event game.

At S18, the overall control CPU 92 receives the event game entry signal. The event game entry signal shows that entry to the event game is made. The event game entry signal is transmitted from the station 1 to which entry was made through the entry operation acceptance process (S59). The overall control CPU 92 receives the event game entry signal from station 1 during a predetermined time. After the predetermined time has lapsed, the overall control CPU 92 shifts the process to S19.

After shifting to S19, the overall control CPU 92 determines whether a predetermined number of (for instance, three) or more stations 1 enter the event game. More specifically, the overall control CPU 92 identifies the stations 1 which enter the event game based on the event game entry signal. As a result, the overall control CPU 92 can judge the number of stations 1 entering the event game, thereby carrying out the judgment process at S19. If the number of stations entering the event game is equal to or above a predetermined number (S19: YES), the overall control CPU 92 shifts the process to S20. On the other hand, if the number of stations 1 entering the event game is below a predetermined number (S19: NO), the overall control CPU 92 ends the event game monitoring process program as is.

At S20, the overall control CPU 92 executes an entry fee collection process. In an entry fee collection process (S20), the overall control CPU 92 collects the entry fee from stations 1 which performed an entry operation. The entry fee represents the counter value for entering the event game, and is collected as gaming value (credits). In this case, the overall control CPU 92 accumulates and adds the collected entry fee as it is to the event game payout. After collecting the entry fee from each station 1 entering the event game and executing the above process, the overall control CPU 92 shifts the process to S21.

After shifting to S21, the overall control CPU 92 transmits the event game start signal with respect to the stations 1 which performed the entry operation. Simultaneously with the transmission of the event game start signal, the overall control CPU 92 references timer 97 and stores information showing the event game start time in the overall control RAM 94. After transmitting the event game start signal, the overall control CPU 92 ends the event game monitoring process program. As will hereinafter be described, the main CPU 42 starts an event game upon receiving this event game start signal. As a result, the stations 1 having performed the entry operation are set in a condition where the event game (unit event game) can be executed.

Here, if the event game is executed (S13: YES), the overall control CPU 92 judges whether the event game period has lapsed (S22). More specifically, the overall control CPU 92 references the information for the event game start time stored in the overall control RAM 94 and timer 97 to judge whether the predetermined event game period has lapsed. If the event game period has lapsed (S22: YES), the overall control CPU 92 shifts the process to S23. On the other hand, if the event game period has not lapsed yet (S22: NO), the overall control CPU 92 ends the event game monitoring process program as is.

At S23, the overall control CPU 92 transmits an event game end signal to station 1 as the event game period has lapsed. The event game end signal shows the end of the event game. After the event game end signal is transmitted to station 1, the overall control CPU 92 shifts the process to S24.

Upon receiving the event game end signal, the main CPU 42 of station 1 executes processes (S75 through S77) with respect to ending of the event game.

After shifting to S24, the overall control CPU 92 executes an event game result judgment process. This event game result judgment process (S24) serves to identify an object station based on the event game results of each station 1 which entered the event game. The object station represents a station 1 to be an object of an event game payout and also represents a station 1 to which a chance game opportunity is to be awarded. That is, the object station corresponds to a station 1 with the best event game result at the event game.

More specifically, at the event game result judgment process (S24), the overall control CPU 92 first receives event game result information from each station 1 which entered the event game. The event game result information is the information transmitted from stations 1 which received the event game end signal (S75). As was described in the above text, the event game result information shows a sum value of the event game points acquired during the event game period. Accordingly, the overall control CPU 92 identifies the station 1 which acquired the most event game points as the object station, based on the event game result information of each station 1. After identifying the object station, the overall control CPU 92 shifts the process to S25.

At S25, the overall control CPU 92 transmits an event game payout signal. This event game payout signal instructs an event game payout and includes the event game payout information at the end of the event game. The event game payout signal is transmitted to the object station identified at the event game result judgment process (S24). After transmitting the event game payout signal, the overall control CPU 92 initializes the event game payout information stored in the overall control RAM 94. After executing the transmittance of the event game payout signal and the initialization of the event game payout, the overall control CPU 92 shifts the process to S26.

At S26, the overall control CPU 92 executes a chance game process. In the chance game process (S26), the overall control CPU 92 executes a chance game process program. As a result, the overall control CPU 92 executes the various types of processes with respect to the execution of the chance game in the object station identified at the event game result judgment process (S26). The chance game process (S26) will be later described in detail by referring to the drawings. After the chance game process ends, the overall control CPU 92 ends the event game monitoring process program.

Next, the chance game process program to be executed at the chance game process (S26) will be described in detail by referring to the drawings. FIG. 13 is a flow chart of the chance game process program.

After starting the execution of the chance game process program, the overall control CPU 92 first executes the chance game result determination process (S31). In this chance game result determination process (S31), the overall control CPU 92 executes a lottery program of the overall control ROM 93 to sample one random number value. Then the overall control CPU 92 determines the chance game result directed to this chance game based on the random number value sampled and the chance game result reference table (refer to FIG. 14).

As shown in FIG. 14, the chance game result reference table is provided with two kinds of chance game result of “WIN” and “LOSE.” Predetermined random number value ranges are related to each chance game result respectively. As a result, the overall control CPU 92 can determine the chance game result as “WIN” or “LOSE” based on the random number value sampled. After storing the chance game result determined by the lottery in the overall control RAM 94, the overall control CPU 92 shifts the process to S32.

After shifting to S32, the overall control CPU 92 transmits a chance game execution signal to the object station. The chance game execution signal serves as a signal instructing to start the execution of the chance game at the object station and includes the chance game result information. This chance game result information shows the chance game result determined at the chance game result determination process (S31). After transmitting the chance game execution signal to the object station, the overall control CPU 92 shifts the process to S33.

Upon receiving the chance game execution signal, the main CPU 42 of the object station executes the chance game execution process program (S63).

At S33, the overall control CPU 92 judges whether the notification-complete signal is received. As described later, the notification-complete signal is transmitted from the object station when the notification of the chance game result to the player directed to the object station is completed (S84: YES). When receiving the notification-complete signal (S33: YES), the overall control CPU 92 shifts the process to S34. Meanwhile, when the notification-complete signal is not yet received (S33: NO), the overall control CPU 92 puts the process in standby until the notification-complete signal is received.

At S34, the overall control CPU 92 judges whether the chance game result is “WIN.” More specifically, the overall control CPU 92 executes the judgment of S34 based on the chance game result information stored in the overall control RAM 94. When the chance game result is “WIN” (S34: YES), the overall control CPU 92 shifts the process to S35. Meanwhile, the chance game result is “LOSE” (S34: NO), the overall control CPU 92 ends the chance game process program as is.

At S35, the overall control CPU 92 transmits a payout awarding signal to the object station. This payout awarding signal includes the information indicating the payout amount at the actual moment. That is, the overall control CPU 92 refers to the chance game payout information in the overall control RAM 94, generates the payout awarding signal, and transmits the generated payout awarding signal to the object station. After transmitting the payout awarding signal, the overall control CPU 92 shifts the process to S36.

Meanwhile, upon receiving the payout awarding signal, the main CPU 42 pays out the chance game payout based on the payout awarding signal (S86).

At S36, the overall control CPU 92 initializes a chance game payout following the transmittance of the payout awarding signal (S35). Namely, the overall control CPU 92 updates the chance game payout information stored in the overall control RAM 94 to the contents indicating the initial value of the chance game payout (e.g., “CHANCE GAME PAYOUT: 0”). After initializing the chance game payout, the overall control CPU 92 ends the chance game process program.

Next, the main game process program executed in each station 1 constituting the gaming machine 100 will be described in detail by referring to the drawings. FIG. 15 is a flow chart of the main game process program executed in station 1.

The game in station 1 according to the present embodiment (specifically, the base game, the event game or the chance game) is realized by executing the main game process program. The main game process program is repeatedly executed during power supply to station 1.

In the following description, each station 1 has already ended initial setting for each station 1 following reception of the initial setting signal transmitted from the overall control CPU 92.

As shown in FIG. 15, after starting execution of the main game process program following the completion of the initial setting, the main CPU 42 judges whether a game start signal is received (S51). This game start signal is a signal transmitted from the overall controller 91 (S2). If a game start signal is received (S51: YES), the main CPU 42 shifts the process to S52. On the other hand, if the game start signal is not yet received (S51: NO), the main CPU 42 puts the process in standby. Specifically, station 1 maintains the standby state until a game start signal is received.

At S52, the main CPU 42 judges whether an event game opening signal was received. This event game opening signal is transmitted if the conditions (S14 through S16) for the event game are satisfied (S17). As above mentioned, the overall control CPU 92 transmits the event game opening signal. If the event game opening signal is received (S52: YES), the main CPU 42 shifts the process to the entry operation acceptance process (S59). As a result, the above station 1 executes the processes relating to the execution of the event game and the chance game (S59 through S63). On the other hand, if the event game opening signal is not received (S52: NO), the main CPU 42 shifts the process to the start acceptance process (S53). In this case, the above station 1 executes the processes (S53 through S58) relating to the execution of the base game.

First, the processes (S53 through S58) relating to the execution of the base game will be described. After shifting to S53, the main CPU 42 executes a start acceptance process. In the start acceptance process (S53), the main CPU 42 accepts a bet operation from the player. More specifically, the above bet operation is carried out upon inserting a coin or operating the BET button. In the start acceptance process, the main CPU 42 transmits a control signal to the sub-control board 72. As a result, the display windows 15 through 17 of the main liquid crystal panel 11B each shift to or are maintained in a transparent state by the sub-control board 72.

After shifting to S54, the main CPU 42 judges whether the start button was operated. More specifically, the main CPU 42 makes the judgment at S54 based on the presence or absence of a signal based on the input operation of the start button.

If the start button was operated (S54: YES), the main CPU 42 executes the predetermined process and shifts the process to S55. More specifically, the main CPU 42 stores the number of bets set in the start acceptance process (S53) as the bet information in RAM 43 and then transmits this bet information to the overall controller 91. As described above, the overall control CPU 92 executes a payout information renewal process (S12) based on the bet information transmitted herein. The main CPU 42 also subtracts the number of bets according to this bet information from the number of credits.

On the other hand, if the start button is not operated (S54: NO), the main CPU 42 returns the process to the start acceptance process (S53). As a result, the player can execute a bet number correction operation, etc.

In the next process S55, the main CPU 42 executes a symbol lottery process. This symbol lottery process (S55) serves to decide the symbols positioned on the main liquid crystal panel 11B by lottery. More concretely, the main CPU 42 executes the above lottery program to sample a random number value from the numerical range of a predetermined random number value range. The main CPU 42 decides each symbol (i.e., the stop position of reels 5 through 7) positioned on the pay line L based on the sampled random number values and the table.

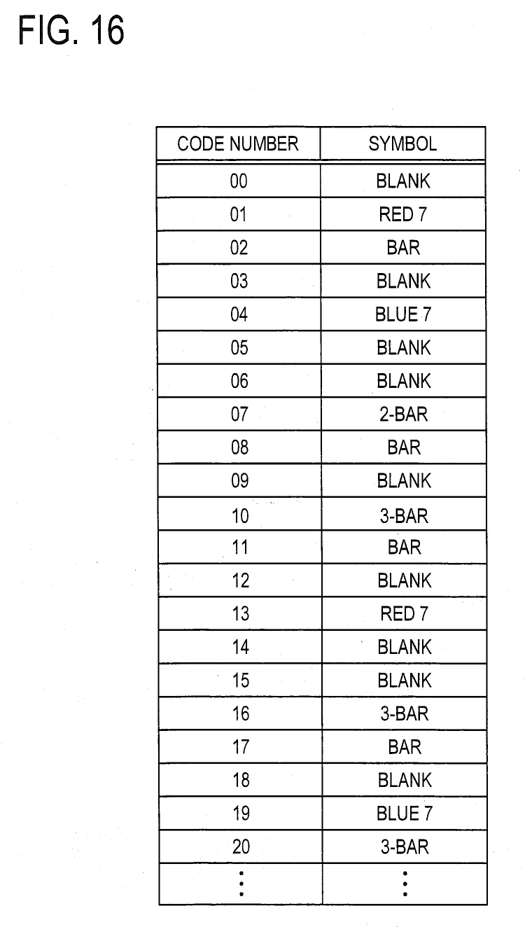

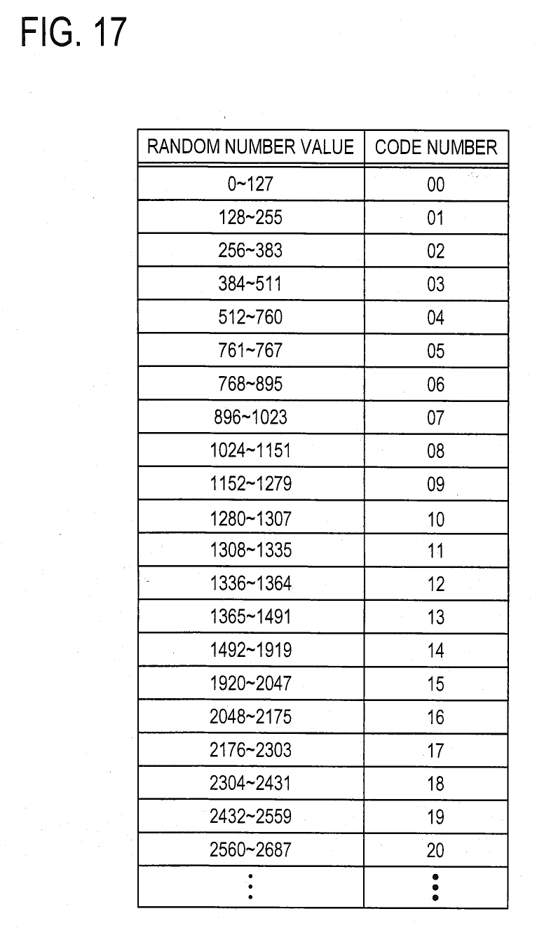

Here, a process using the random number values in the symbol lottery process (S55) will be described based on the drawings. FIG. 16 is one example of a table showing associations between the symbols drawn on one reel band and code numbers. FIG. 17 is one example of a table showing the association between random number values and code numbers. The table showing associations between symbols and code numbers (for instance, FIG. 16) contains associations with respect to the left reel 5, the center reel 6 and the right reel 7.

As was described in the above text, in the symbol lottery process (S55), the main CPU 42 executes the lottery program to sample random number values from the predetermined random number range (for instance 0 through 65535). The main CPU 42 then decides the code numbers based on the sampled random number values and the table containing associations between the random number values and the code numbers (refer to FIG. 17, for instance). The main CPU 42 decides the symbols to be positioned on the pay line L among the symbols included on the reels, based on the code numbers and the table containing associations between the symbols and the code numbers (refer to FIG. 16). As a result, the main CPU 42 can decide a symbol combination constituted by three symbols positioned on the pay line L.

For instance, if the left reel 5 is the reel band shown in FIG. 16 and random number value “1136” is sampled, the main CPU 42 decides for code number “08” based on the random number value “1136” and the table shown in FIG. 17. Then, the main CPU 42 decides the symbol positioned on the pay line L in display window 15 to be the bar symbol 90E based on the code number “08” and the table shown in FIG. 16.

The process using random number values in the symbol lottery process (S55) is not limited to the process using random number values, a table containing associations between random number values and code numbers (refer to FIG. 17, for instance) and a table containing associations between symbols and code numbers (refer to FIG. 16).

For instance, direct associations can be made between random number values to be sampled and symbols. The symbols to be stopped and displayed can also be decided using direct associations between the random number values to be sampled and winning combinations and the above tables.

The processes following the symbol lottery process (S55) in the main game process program will now be described by referring to FIG. 15.

After the symbol lottery process (S55) ends, the main CPU 42 executes a reel rotation control process (S56). More specifically, the main CPU 42 drives motors M1, M2 and M3 through a motor driving circuit 52. As a result, reels 5 through 7 start spinning. Thereafter, the main CPU 42 decides the effect pattern with respect to the unit game (the image display pattern onto the main liquid crystal panel 11B and the sound output pattern from speaker 31) and transmits an effect signal to the sub-control board 72, etc. Station 1 then starts effect execution using the decided effect pattern based on the control of the sub-control board 72. When the predetermined time has lapsed, the main CPU 42 performs a reel stop operation. Specifically, the main CPU 42 stops reels 5 though 7 through the motor driving circuit 52. At this time, the main CPU 42 stops reels 5 through 7 based on a code number decided in the symbol lottery process (S55). As a result, the symbol combination decided at S55 is repositioned on the pay line L. The main CPU 42 ends the reel rotation control process (S56) following stopping of reels 5 through 7 and then shifts the process to S57.

After shifting to S57, the main CPU 42 judges whether the predetermined winning combination is established on the pay line L or not. In other words, the main CPU 42 judges whether a symbol combination repositioned on the pay line L corresponds to the winning combination (refer to FIG. 11). More specifically, the main CPU 42 judges whether the symbol combination repositioned on the pay line L corresponds to the winning combination based on the code numbers, etc. of reels 5 through 7. If the winning combination is established (S57: YES), the main CPU 42 moves the process to the payout process (S58). On the other hand, if the winning combination is not established (S57: NO), the main CPU 42 ends the main game process program. In this case, if a game starts following the next game, the main CPU 42 executes the processes following process S51 once again.

At S58, the main CPU 42 executes a payout process. In this payout process (S58), the main CPU 42 pays out an award (i.e., a payout) corresponding to the associated winning combination to the player. In this point, a payout method can be adopted in which coins corresponding to the number of credits (1 credit corresponds to 1 coin) are paid out when the CASHOUT button is held down. A payout method can also be adopted in which payment is made by tickets with a bar code. After ending the payout process (S58), the main CPU 42 ends the main game process program. In this case, the main CPU 42 starts execution of the main game process program again, and executes the process at S51.

The processes S53 through S58 constitute a single unit game to be executed in the base game.

Next, the processes (S59 through S63) regarding execution of the event game in the main game process program will be described. As was described in the above text, if an event game opening signal is received (S52: YES), the main CPU 42 shifts the process to S59.

At S59, the main CPU 42 executes an entry operation acceptance process. In this entry operation acceptance process (S59), the main CPU 42 accepts the operation of a player showing entry to the event game (i.e., entry operation). The operation of the player showing entry was not made to the event game is referred to as non-entry operation.

More specifically, the main CPU 42 displays “a message urging entry to the event game” and “a message that an entry fee is required when executing the event game” on the main liquid crystal panel 11B.

Further, the main CPU 42 displays a selection on the main liquid crystal panel 11B with respect to entry to the event game (i.e., “select: entry” and “select: non-entry”). Accordingly, a player playing at station 1 can judge whether to enter the event game or not, appropriately. And the player can carry out the entry operation or the non-entry operation.

The entry operation and the non-entry operation are carried out using the touch panel 18. Specifically, the player executes the entry operation by touching the touch panel 18 corresponding to the “select: entry” portion. The player executes the non-entry operation by touching the touch panel 18 at the “select: non-entry” portion. If the entry operation was executed, the main CPU 42 transmits an event game entry signal to the overall controller 91. After transmitting the event game entry signal, the main CPU 42 shifts the process to S60.

If the non-entry operation was carried out, the main CPU 42 transmits the event game non-entry signal to the overall controller 91.

After shifting to S60, the main CPU 42 judges whether the event game start signal was received. The event game start signal serves to start the event game. As was described in the above text, the event game start signal is transmitted from the overall controller 91 to the station 1 which performed the entry operation, if the predetermined conditions (S14 through S16, and S19) are satisfied. If the main CPU 42 receives the event game start signal (S60: YES), it shifts the process to the event game execution process (S61). In this case, the above station 1 performs specific processes with respect to execution of the event game. On the other hand, if the main CPU 42 does not receive the event game start signal (S60: NO), it shifts the process to S53. In this case, the above station 1 executes processes (S53 through S58) relating to execution of the base game. Specifically, the above station 1 does not execute the event game.

After shifting to S61, the main CPU 42 executes the event game execution process. This event game execution process (S61) serves to execute a unit event game in the above station 1 independently from the other stations 1. In this event game execution process (S61), the main CPU 42 executes the event game execution process program. The event game execution process program will be described in detail by referring to the drawings. After ending the event game execution process (S61), the main CPU 42 shifts the process to S62.

At S62, the main CPU 42 judges whether a chance game execution signal has been received. The chance game execution signal serves as a signal to instruct the start of a chance game execution at the station 1. Then the chance game execution signal is transmitted from the overall controller 91 to the object station (S32). If the main CPU 42 receives the chance game execution signal (S62: YES), it stores the chance game result information involved in the chance game execution signal in the RAM 43 and shifts the process to S63. On the other hand, if the main CPU 42 does not receive the chance game execution signal (S62: NO), it ends the main game process program as is. That is, the main CPU 42 shifts the process to the chance game execution process (S63) only if the station 1 is the object station.

After shifting to S63, the main CPU executes a chance game execution process. In the chance game execution process (S63), the main CPU 42 executes a chance game execution process program to be later described. As a result, the player can execute a chance game at the station 1. The chance game execution process (S63) will be described in detail referring to the drawings. After ending the chance game execution process (S63), the main CPU 42 ends the main game process program. In this case, the main CPU 42 starts the main game process program once again, and executes the process of S51.

Next, the event game execution process program executed by the main CPU 42 at S61 will be described in detail by referring to the drawings. FIG. 18 is a flow chart of the event game execution process program.

After shifting to the event game execution process (S61), the main CPU 42 executes a symbol lottery process (S71). This symbol lottery process (S71) is similar to the symbol lottery process (S55) in the base game. Therefore, the symbol lottery process (S71) will not be described in detail here. After determining the symbol combination to be positioned on the pay line L in the unit event game, the main CPU 42 shifts the process to S72.

At S72, the main CPU 42 executes a reel rotation control process. This reel rotation control process (S72) is similar to the reel rotation control process (S56) in the base game. Accordingly, the symbols are scroll displayed by rotation of the reels in the display windows 15, 16 and 17 also in the unit event game (refer to FIG. 9) similarly to the unit game directed to the base game. When rotation of the reels is stopped based on the lapse of the predetermined period, the symbols are repositioned based on the lottery results of the symbol lottery process (S71). After repositioning the symbols based on the lottery results, the main CPU 42 shifts the process to S73.

After shifting to S73, the main CPU 42 executes the point addition process. This point addition process (S73) serves to judge the event game points composing the game result of the unit event game and at the same time to determine the game result of the event game. More specifically, the main CPU 42 calculates the event game result (i.e., event game point) in the unit event game with the three symbols positioned on the pay line L as the object.

Here, the calculation of event game points in the unit event game will be described in detail by referring to the drawings. Upon calculating the event game points, the main CPU 42 references the lottery results of the symbol lottery process (S71) and the event game point table shown in FIG. 19. As shown in FIG. 19, the event game point table contains event game points set for each type of symbol. For instance, the red seven symbol 90B is associated with “50 points”.

Here, calculation of the event game points for the unit event game will be described taking as example the case that symbols are repositioned in the manner shown in FIG. 10. In the case shown in FIG. 10, “bar symbol 90E”, “triple bar symbol 90C” and “red seven symbol 90B” are positioned on the pay line L. Accordingly, these three symbols become the object for calculating the event game points in the above unit event game.

Then, as shown in FIG. 19, “10 points” are associated to the “bar symbol 90E” and “30 points” are associated to the “triple bar symbol 90C”. Accordingly, the total number of event game points for the unit event game in this case is “90 points” which adds up “10 points”, “30 points” and “50 points”.

The event game points of the unit event game calculated as shown above are added to the present event game points as needed. Specifically, the player can obtain even higher event game points with the execution of the unit event game. After adding the event game points for the current unit event game to the present event game points, the main CPU 42 ends the point addition process (S73). After ending the point addition process (S73), the main CPU 42 moves the process to S74.

The unit event game according to the present embodiment is realized by executing the processes from S71 through S73.

After shifting to S74, the main CPU 42 judges whether the event game period has lapsed. More specifically, the main CPU 42 judges whether an event game end signal was received. Here, as was described in the above text, the event game end signal is transmitted from the overall control CPU 92 referring to the timer 97 if the event game period has lapsed (S23). Accordingly, the main CPU 42 can judge whether the event game period has lapsed by judging whether the event game end signal was received. If the event game period has lapsed (S74: YES), the main CPU 42 shifts the process to S75. On the other hand, the main CPU 42 returns the process to S71 if the event game period has not lapsed yet (S74: NO). As a result, the player can execute a new unit event game. Specifically, the player can play the unit event game a plurality of times as long as it is within the event game period.

At S75, the main CPU 42 transmits the event game result information to the overall controller 91. This event game result information shows the game results for the event game at the time of ending the event game (i.e., the total value of the event game points obtained). As described above, the event game result information is used as judging reference for identifying the station 1 that obtained the best event game results (i.e., the object station) at the event game result judgment process (S24). After transmitting the event game result information to the overall controller 91, the main CPU 42 shifts the process to S76.

After shifting to S76, the main CPU 42 judges whether the event game payout signal was received. The event game payout signal serves to instruct an event game payout with respect to the above station 1. The above event game payout signal includes information showing the event game payout amount at the end of the event game. The event game payout signal is transmitted (S25) to the object station based on the judgment results in the event game results judgment process (S24). Specifically, if the above station 1 is the station 1 that obtained the best event game results, the main CPU 42 receives the event game payout signal.

If the event game payout signal is received (S76: YES), the main CPU 42 shifts the process to S77. On the other hand, if no event game payout signal is received (S76: NO), the main CPU 42 ends the event game execution process program as is. In this case, the player of the above station 1 cannot obtain an event game payout in the current event game.

At S77, the main CPU 42 executes the event game payout process. In this event game payout process (S77), the main CPU 42 awards an event game payout, based on the event game payout signal, to the player. As a result, the player that obtained the best event game results obtains an event game payout which is a progressive payout. After ending the event game payout process (S77), the main CPU 42 ends the event game execution process program.

Next, a chance game execution process program executed at S63 will be described in detail referring to the drawings. FIG. 20 is a flowchart of a chance game execution process program.

Here, the detailed description of contents of a chance game and a chance game screen is given referring to the drawings. The chance game screen is a screen displayed on a main liquid crystal panel 11B at chance game execution.

As shown in FIG. 22, the chance game screen includes a lottery image 110 representing the above-mentioned “scratch-off lottery ticket.” The lottery image 110 has nine result display areas 111. In the lottery image 110, the result display areas 111 are positioned in a matrix of three by three.

A scratch objective image 112 and a symbol image 113 are displayed in each of the result display areas 111. There are two kinds of symbol image 113, a winning symbol image 113A and a losing symbol image 113B (refer to FIG. 22). The winning symbol image 113A is an image representing the same symbol as the blue seven symbol 90A. The losing symbol image 113B is an image representing the same symbol as the blank symbol 90F.

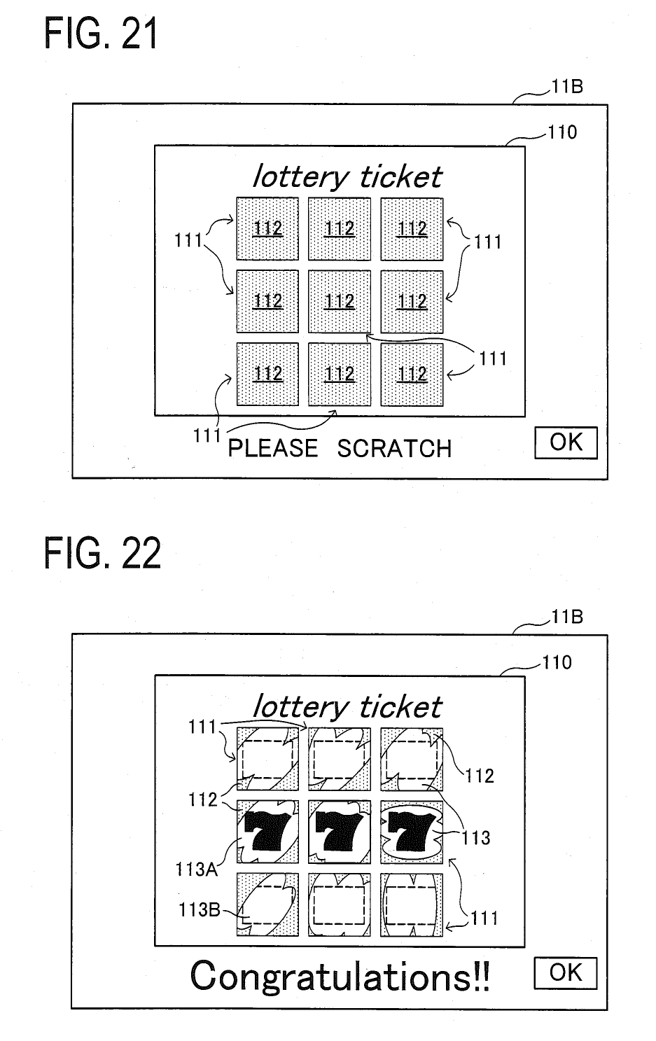

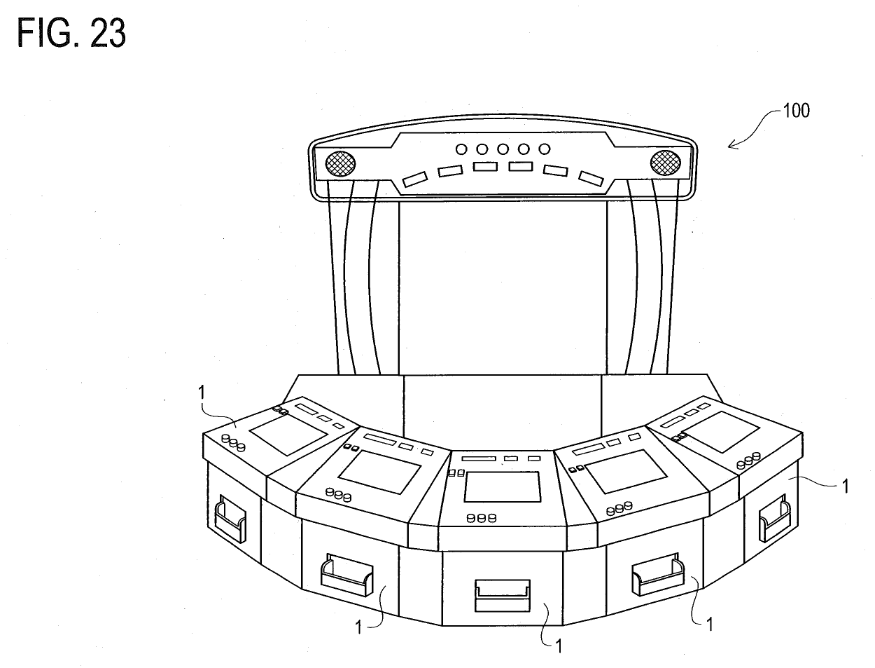

In the event game, a scratch object image 112 is first displayed on each of the result display areas 111 (refer to FIG. 21). When the player conducts a scratch operation to the scratch objective image 112 displayed on a result display area 111, a symbol image 113 is displayed (refer to FIG. 22). Accordingly, by conducting the scratch operation to the nine result display areas 111, the player can have the symbol images 113 displayed on the result display areas 111.

Then, the station 1 displays three winning symbol images 113A positioned vertically, horizontally, or diagonally in line on the nine result display areas 111 in case of “chance game result: WIN”. The position pattern of the winning symbol images 113A in this case is called a “winning pattern”. Accordingly, eight types of winning pattern are provided for this embodiment. For instance, the chance game screen shown in FIG. 22 can notify “chance game result: WIN” to the player. The position pattern of the winning symbol images 113A is a kind of winning pattern above mentioned. Meanwhile, in case of “chance game result: LOSE”, the station 1 does not display three winning symbol images 113A in the nine result display areas 111. Consequently, the station 1 can notify the player of the “winning the chance payout or not” via the position pattern of the winning symbol images 113A displayed by the scratch operation.

Then, a chance game execution process program will be described in detail. Upon receiving a chance game execution signal (S62: YES), the main CPU 42 starts the execution of a chance game execution process program at S63. The main CPU 42 first executes a chance game screen display process (S81). In this chance game screen display process (S81), the main CPU 42 displays a chance game screen on the main liquid crystal panel 11B through the sub-control board 72 (refer to FIG. 21). More specifically, the main CPU 42 displays on the main liquid crystal panel 11B a chance game screen including a lottery image 110 through the sub-control board 72. At this point, the scratch objective images 112 are displayed on all the result display areas 111 included in the lottery image 110 (refer to FIG. 21).

In addition, at this chance game screen display process (S81), the main CPU 42 determines the position pattern of the winning symbol images 113A based on the chance game result information stored in RAM 43. For instance, in case of “chance game result: UVIN”, the main CPU 42 determines one winning pattern among eight types of winning pattern. Next, the main CPU 42 stores position pattern information in RAM 43. The position pattern information is the information showing the determined position pattern of the winning symbol images 113A.

After shifting to S82, the main CPU 42 judges whether a scratch operation is executed. The scratch operation is an operation executed by a player onto a touch panel 18 corresponding to the result display area 111 on which scratch objective images 112 are displayed. The player executes a scratch operation by touching the objective portion of the touch panel 18 with a finger, and the like. Therefore, the main CPU 42 executes a judgment of S82 based on an operation signal from the touch panel 18. If a scratch operation is executed (S82: YES), the main CPU 42 shifts the process to S83. Meanwhile, if a scratch operation is not executed (S82: NO), the main CPU 42 puts the process on standby.

After shifting to S83, the main CPU 42 executes a game screen display change process. In the game screen display change process (S83), the main CPU 42 changes the scratch objective image 112 in a portion touched at the scratch operation on the result display area 111 where the scratch operation is executed to the corresponding symbol image 113. After executing the image display change at the result display area 111, the main CPU 42 shifts the process to S84.

Here, the display change at the game screen display change process (S83) will be described in more detail. As described above, the scratch operation is executed using the touch panel 18. Then, the touch panel 18 transmits to the main CPU 42 an operation signal corresponding to a portion that the player has touched. That is, the main CPU 42 can identify the portion that the player has touched at the scratch operation. Also, in the position pattern information stored in RAM 43 the respective symbol images 113 (i.e., winning symbol images 113A or losing symbol images 113B) are related to corresponding result display areas 111.

Accordingly, at the game screen display change process (S83), the main CPU 42 first refers to the operation signal based on the scratch operation. As a result, the main CPU 42 identifies the image area corresponding to the portion touched at the scratch operation (hereinafter referred to as object image area) at the result display areas 111 where the scratch operation is executed. After that, the main CPU 42 refers to the position pattern information. As a result, the main CPU 42 can identify the symbol image 113 corresponding to the result display area 111 where the scratch operation has been executed. That is, the main CPU 42 can identify the image area corresponding to the object image area at the identified symbol image 113. Then, the main CPU 42 changes the display on the object image area into an image corresponding to the image area at the identified symbol image 113 and displays the image.

As a result, a user gets a sense that the symbol image 113 has become visible as a result of the scratch operation where the scratch object image 112 was scratched off. That is, the user feels as if he has removed a scratch print on an actual “scratch-off lottery.” Consequently, the station 1 can enhance a sense of realism of the player, thus enables the enhancement of interest related to the chance game.

Upon shifting to S84, the main CPU 42 judges whether a notification of the chance game result is complete. More specifically, the main CPU 42 executes a judgment of S84 based on whether symbol images 113 are displayed on the nine result display areas 111. If the chance game result notification is complete (S84: YES), the main CPU 42 shifts the process to S85. Meanwhile, if the chance game result notification is not complete (S84: NO), the main CPU 42 returns the process to S82. As a result, the player can repeat the scratch operation.

Upon shifting to S85, the main CPU 42 judges whether a payout awarding signal is received. The payout awarding signal is a signal instructing a chance game payout and includes the current chance game payout information. Also, the payout awarding signal is transmitted from the overall controller 91 in case of “chance game result: WIN” (S35). If the payout awarding signal is received (S85: YES), the main CPU 42 shifts the process to S86. Meanwhile, if the payout awarding signal is not received (S85: NO), the main CPU 42 ends the chance game execution process program as is. In this case, the player cannot obtain the chance game payout.

In S86, the main CPU 42 executes a chance game payout process (S86). At the chance game payout process (S86), the main CPU 42 pays out to the player the chance game payout based on the chance game payout information included in the payout signal. As a result, the player who has won the chance game obtains both the event game payout and the chance game payout which is a progressive payout. After the chance game payout process (S86) is ended, the main CPU 42 ends the chance game execution process program.

As was described in the above text, in the gaming machine 100 according to the present embodiment, the five stations 1 execute the base game (S53 through S58) independently from each other. In this base game, each station 1 decides one game result (i.e., symbol combination) (S55), and executes the base game. At this time, the above station 1 is not influenced in any way by the other stations 1.

Here, the event game is executed in the above gaming machine 100 if the predetermined conditions (S14 through S16, and S19) are satisfied. In the above event game, the players playing at a plurality (for instance, three or more) of stations 1 compete to obtain an event game payout. The event game is constituted by a plurality of unit event games executed during the event game period. Specifically, the game results of the event game are obtained by summing up the results of the unit event games executed within an event game period. The event game payout is awarded to players playing at the object station. In other words, the event game payout is awarded to players that obtained the best game results in the event game. Since the event game payout is a progressive payout, this attracts players who want much amount of payout award.

As a result, the above gaming machine 100 can provide the players with new interest which differs from the base game by enabling execution of the event game.

Furthermore, the gaming machine 100 awards an opportunity of a chance game to the player with the best game result in the event game. If the chance game result is “chance game result: WIN,” the player is awarded a chance game payout. The chance game payout is a progressive payout. That is, in this case, the player can obtain a chance game payout together with an event game payout. Thus, the gaming machine 100 can offer an opportunity to obtain further more amount of payout for the player who wants much amount of payout award. As a result, the gaming machine 100 can further enhance the interest of a player playing at the gaming machine 100.

Also, the gaming machine 100 carries over the current chance game payout to the “next or later chance game payout” in a case of “chance game result: LOSE”. That is, the amount of the next or later “chance game payout” becomes the amount obtained by accumulating and adding the predetermined amount to the chance game payout. As a result, at the next or later chance game, the player can obtain much higher amount of chance game payout. Accordingly, the gaming machine 100 can enhance the expectation of obtaining the high amount of chance game payout needless to say for the player who could not win the chance game payout at the current chance game, but also for the player who could not obtain an opportunity of chance game execution.

It is to be noted that the present invention is not limited to the above-described embodiment but, not to mention, it can be improved and modified in various ways within its scope and without departing from the subject matter thereof. For instance, the present invention can also be realized as a gaming machine of the type shown in FIG. 21.

In the above description, in the gaming machine 100 according to the present embodiment, each station executes a base game and an event game having a slot game as base, however, the present invention is not limited to this aspect. Specifically, the present invention can be realized by executing a base game and an event game having a card game such as poker or black jack, etc. as base.

Further, in the above description, the gaming machine 100 according to the present embodiment executes a base game and an event game having the same type of game (slot game in the case of the present embodiment) as base, however, the invention is not limited to this aspect. Specifically, the base game and the event game may also have as base a game of a different type. For instance, a “slot game” can be adopted as a base game, and a “card game” can be adopted as an event game. In this case, the event game has to satisfy conditions such as “stations 1 that entered the game can advance the unit event game independently” and “the plurality of stations that entered the game compete for a common award”.

In the above embodiment, event game points based on three symbols positioned on the pay line L represent game results for the unit event game, however, the present invention is not limited to this aspect. For instance, nine symbols which can be visually recognized through the respective display windows 15, 16 and 17 may represent event game point calculation objects and may also represent game results of the unit event game.

Further, in the present embodiment, a station 1 awarding an opportunity of chance game execution is the same station (i.e., object station) as a station 1 awarding an event game payout, however, the invention is not limited to this aspect. That is, the station 1 awarding an opportunity of chance game execution may be a station 1 identified by the result of the event game. For instance, the process can be configured to award an “event game payout” to a station 1 which has achieved the best game result at an event game, and to award “an opportunity to execute a chance game” to a station 1 which has achieved the second best game result at the event game.

In addition, in the present embodiment, a chance game payout is configured as a progressive payout, however, the invention is not limited to this aspect. For instance, the process can be configured to award “predetermined amount of gaming value” as chance game payout. Also, the content of the “second special prize” is not limited to the direct awarding of gaming value. For instance, the process can be configured to award the predetermined number of so-called “free game.” In this case, if the chance game result is “LOSE”, a certain number of free games can be accumulated and added to the predetermined number of the free game.

The station 1 according to the present embodiment is a slot machine executing a slot game using three mechanical reels, however, it may also execute a slot game using five reels or nine reels, etc. A slot machine having video reels may also be used.

The present invention can be realized as a game method for executing the above processes. Further, the present invention can also be realized as a program for executing the above game method on a computer and a recording medium onto which this program is recorded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
plural stations each of which determines a game result and executes a game independently; and
a processor which executes:
(a) a process to execute a base game independently at each station;
(b) a process to accept each station's entry to an event game executed in common to plural stations when a predetermined condition is satisfied;
(c) a process to execute the event game in plural stations of which entries to the event game have been accepted;
(d) a process to determine and award a first special prize to each station based on a game result of each station that has participated in the event game;
(e) a process to give a chance game which may award a second special prize, to a station specified in accordance with a game result of the event game;
(f) a process to determine whether or not to award a second special prize by a lottery when executing a chance game to the station specified at the process (e); and
(g) a process to award the second special prize to the station specified at the process (e) when the second special prize is won.

2. A gaming machine comprising:
plural stations each of which determines a game result and executes a game independently; and
a processor which executes:
(a) a process to execute a base game independently at each station;
(b) a process to accept each station's entry to an event game executed in common to plural stations when a predetermined condition is satisfied;
(c) a process to execute the event game in plural stations of which entries to the event game have been accepted;
(d) a process to determine and award a first special prize to each station based on a game result of each station that has participated in the event game;
(e) a process to specify a station which has achieved a best game result by comparing respective game results of each station at the event game and to give a chance game which may award a second special prize, to a station specified thereby;
(f) a process to determine whether or not to award a second special prize by a lottery when executing a chance game to the station specified at the process (e); and
(g) a process to award the second special prize to the station specified at the process (e) when the second special prize is won.

3. A gaming machine comprising:
plural stations each of which determines a game result and executes a game independently; and
a processor which executes:
(a) a process to execute a base game independently at each station;
(b) a process to accept each station's entry to an event game executed in common to plural stations when a predetermined condition is satisfied;
(c) a process to execute the event game in plural stations of which entries to the event game have been accepted;
(d) a process to determine and award a first special prize to each station based on a game result of each station that has participated in the event game;
(e) a process to specify a station which has achieved a best game result by comparing respective game results of each station at the event game and to give a chance game which may award a second special prize, which is a progressive payout, to a station specified thereby;
(f) a process to determine whether or not to award a second special prize by a lottery when executing a chance game to the station specified at the process (e); and
(g) a process to award the progressive payout according to the second special prize to the station specified at the process (e) when the second special prize is won, or to carry over the progressive payout according to the second special prize to a next chance game or later, when the second special prize is not won.
